(19) United States
(12) Patent Application Publication
(10) Pub. No.: US 2025/0105307 A1
(43) Pub. Date: Mar. 27, 2025

(54) MIXED-IONIC-ELECTRONIC-CONDUCTING OXIDES TREATED TO MEDIATE, PREVENT, OR REVERSE POISONING AND/OR ENHANCE PERFORMANCE

(71) Applicant: Massachusetts Institute of Technology, Cambridge, MA (US)

(72) Inventors: Harry L. Tuller, Wellesley Hills, MA (US); Clement Nicollet, La Chapelle-sur-Erdre (FR); Anna F. Staerz, Cambridge, MA (US); Han Gil Seo, Quincy, MA (US)

(73) Assignee: Massachusetts Institute of Technology, Cambridge, MA (US)

(21) Appl. No.: 18/729,848

(22) PCT Filed: Apr. 5, 2023
(86) PCT No.: PCT/US2023/017632

§ 371 Date: Jul. 17, 2024

Related U.S. Application Data
(60) Provisional application No. 63/327,454, filed on Apr. 5, 2022.

(51) Int. Cl. H01M 4/90; H01M 4/86

(52) U.S. Cl. CPC H01M 4/9033; H01M 4/8657

(57) ABSTRACT

Some aspects of the present disclosure are related to modified electrodes, for example, for use in fuel cells. In some cases, the electrode may comprise a mixed-ionic-electronic-conducting (MIEC) oxide and a basic oxide. In some cases, the basic oxide may alter the electron density of the MIEC oxide and improve its catalytic performance, for example, like the oxygen reduction reaction. For instance, the catalytic performance of a MIEC oxide comprising a perovskite towards the oxygen reduction reaction (ORR) may be improved by using a basic oxide comprising CaO and/or Li₂O. Some aspects disclosed herein are directed to methods of preventing or treating chromia or silica poisoning of a MIEC oxide, wherein the method comprises treating the MIEC electrode with a basic oxide infiltrant.

### RELATED APPLICATIONS

This application claims priority under 35 U.S.C. § 119 (e) to U.S. Provisional Patent Application No. 63/327,454, filed Apr. 5, 2022, and entitled “MEANS FOR MITIGATING POISONING AND/OR ENHANCING PERFORMANCE OF METAL OXIDE-BASED DEVICES RELYING ON OXYGEN ADSORPTION AND/OR EXCHANGE,” which is incorporated herein by reference in its entirety for all purposes.

### GOVERNMENT SPONSORSHIP

This invention was made with government support under DE-FE0031668 awarded by the Department of Energy. The government has certain rights in the invention.

### BACKGROUND

Metal oxides are an important class of functional materials for a wide array of applications, ranging from energy storage and conversion (e.g., fuel cells, electrolysis cells, and permeation membranes) and catalysis to sensors. In many of these cases, the reaction of oxygen with the metal oxide surface plays a central role. A great deal of effort is invested in optimizing the metal oxide's initial performance. Nevertheless, the commercial viability of such devices is often markedly depressed as a result of unacceptable performance degradation rates with operating time, e.g., due to chromia poisoning of mixed-ionic-electronic-conducting (MIEC) solid oxide fuel cell (SOFC) cathodes or silica poisoning of gas sensors. Generally, to achieve long term stability, engineers aim to render the surface more robust against poisons, while others propose methods to limit poison exposure.

Metal oxides, given their high thermal and chemical stability, coupled with a wide range of electrical, electrochemical, optical and magnetic properties are attractive candidates for a growing array of applications. Here, we are particularly interested in electrochemical applications, broadly conceived, in which both ions and electrons play key roles in device operation and where exchange of oxygen between the gas and solid phase is likewise essential for operation. Examples include metal oxide gas sensors (semiconducting and electrolytic), SOFC, and solid oxide electrolysis cells (SOEC), oxygen permeation membranes, oxygen storage materials, solar thermochemical reactors, and metal oxide-based catalysts.

As might be expected, surfaces and interfaces play key or essential roles in the operation of all of these types of devices. For example, semiconducting metal oxide (SMOX) sensors depend on the adsorption/diffusion of gas species on the surfaces or exposed grain boundaries and subsequent charge transfer between the semiconductor and the adsorbed gas atoms or molecules for their operation. Fuel cells require the reduction of oxygen molecules at the cathode and subsequent incorporation into the electrolyte, diffusion across the electrolyte, (including across grain boundaries within the electrolyte) and subsequent oxidation of the oxygen ions at the anode and their exit back into the gas phase by reaction with reactive gas phase hydrocarbons or hydrogen to form CO, CO₂, and/or H₂O. Understandably, any process that interferes with these surface or interface reactions is undesirable. This may take the form of inert layers of materials that literally block access of oxygen, electrons or other reactive species to respective surfaces or interfaces or “poison” the catalytic activity of surface or interface sites needed for the efficient functioning of the devices. One omnipresent chemical specie that appears to serve to “poison” the operation of many such electrochemical devices is some form of silica or SiOₓ, or in combination of other cations to form silicates. Another common poison for SOFC cathodes is chromia, which originates from the stack interconnects and is known to significantly degrade the surface activity to oxygen.

A great deal of effort is invested in optimizing the metal oxide's initial performance. Nevertheless, the commercial viability of such devices is often markedly depressed as a result of unacceptable performance degradation rates with operating time, e.g., due to chromia poisoning of MIEC SOFC cathodes or silica poisoning of gas sensors. The chemical degradation of surfaces due to both internal and external poisoning sources limits the long-term performance of metal oxides in a variety of application fields ranging from energy storage and conversion to sensors. Degradation in performance is often associated with decreased oxygen surface exchange kinetics. Many studies have focused on optimizing the initial surface exchange kinetics, e.g., in SOFC/SOEC, permeation membranes and solar thermochemical reactors.

While the initial reactivity is important, maintaining performance over time is critical and often less examined. Today acceptable performance and degradation values (0.2-0.5% per 1,000 hrs) are attained with single cells, but reliability and endurance must be increased in stacks where degradation rates are 2-4 times higher, due to, e.g., Cr-poisons. The US Department of Energy has set the ambitious goal of reaching a stack voltage degradation rate target of 0.2%/1,000 hours by 2035-2050. Assuming degradation targets can be met, a global SOFC market size of $5.3 billion by 2028 is projected. Identifying means for either protecting active surfaces against poisons or recovering the degraded performance of poisoned metal oxide interfaces would thus have great value in rendering this technology commercially viable.

Currently the most common way of addressing degradation through poisoning is taking great lengths to avoid the sources of such materials, e.g., silica and chromia. In general, this means avoiding all Si-sources during processing of the materials, e.g., silicone-based greases, and antifoaming agents. Due to the ever-increasing use of silicone-based materials, this approach is no longer feasible. For example, while biogas from waste-water and landfills is a promising source of fuel, it is so readily contaminated with siloxanes that they must be actively removed through adsorption onto activated carbon to prevent deactivating fuel cells and lambda probes (AC). Another common poison that degrades fuel cell cathodes is chromia that originates from the interconnects used in SOFC stacks. While barrier coatings (e.g., (Mn,Cr)₃O₄ spinel) have been applied to the Cr containing metal interconnects with the objective of reducing Cr volatility, they have not succeeded in completely mitigating long-term Cr induced cathode electrochemical degradation. In addition to limiting exposure to impurity sources, strategies to make SOFC cathodes more robust through, e.g., the addition of getters, have been investigated. Two notable examples are the work of Bishop et al. in which the addition of a La₂O₃ thin layer was found to recover, to a significant extent, the degradation in the oxygen exchange rate resulting from silica, and Liu et al. who found enhanced tolerance of (La,Sr)(Co,Fe)O₃ (LSCF) against Cr-poisoning through infiltration with a multiphase additive. In the latter case, the increased tolerance was specifically attributed to the BaCO₃ phase of the additive. In both cases the rationale for selecting the additive is based on empirical findings, i.e., the gettering ability of La₂O₃ or previous success with a multiphase additive. However, no comprehensive model predicts the efficacy of additives in compensating degradation and thus progress has depended on trial and error to achieve even modest improvements.

### SUMMARY

Some aspects of the present disclosure are related to modified electrodes, for example, for use in fuel cells. The subject matter of the present disclosure involves, in some cases, interrelated products, alternative solutions to a particular problem, and/or a plurality of different uses of one or more systems and/or articles.

This Summary introduces a selection of concepts in simplified form that are described further below in the Detailed Description. This Summary neither identifies key or essential features, nor limits the scope, of the claimed subject matter.

Some aspects are related to articles. In some embodiments, the article comprises a solid oxide fuel cell, comprising an electrode comprising a mixed-ionic-electronic-conducting (MIEC) oxide having a surface and a basic oxide present on at least a portion of the surface of the MIEC oxide.

Some aspects are related to electrodes. In some cases, the electrode comprises a mixed-ionic-electronic-conducting (MIEC) oxide having a surface and a glassy and/or crystalline product oxide present on at least a portion of the surface of the MIEC oxide, the glassy and/or crystalline product oxide comprising a basic oxide and an acidic oxide comprising at least one of chromia and silica. In some cases, the electrode comprises a mixed-ionic-electronic-conducting (MIEC) oxide having a surface and a basic oxide present on the surface of the MIEC electrode in an amount greater than or equal to 10⁻¹⁰ g/cm² and less than or equal to 10⁻⁶ g/cm². In some cases, the electrode comprises a mixed-ionic-electronic-conducting (MIEC) oxide having a surface and a basic oxide present on less than 1.5% of the surface of the MIEC oxide. According to some embodiments, the electrode comprises a mixed-ionic-electronic-conducting (MIEC) oxide having a surface and a basic oxide present on greater than 3% and less than or equal to 5% of the surface of the MIEC oxide.

In another aspect, the article comprises a solid oxide fuel cell (SOFC) comprising an electrode comprising a mixed-ionic-electronic-conducting (MIEC) oxide having a surface and a basic oxide present on at least a portion of the MIEC oxide, wherein the MIEC oxide configured to be periodically refreshed to maintain its ability to delay or retard poisoning by chromia or silica, by periodically replenishing a basic oxide by a vapor phase infiltration (e.g. by a CVD or ALD process) following assembly of the SOFC structure.

In another aspect, the electrode comprises a mixed-ionic-electronic-conducting (MIEC) oxide having a surface and a basic oxide present on at least a portion of the surface of the MIEC oxide, wherein the basic oxide coating is immobilized on the MIEC surface via predominantly ionic bonding.

Some aspects are related to methods. In some cases, the method comprises providing a solid oxide fuel cell comprising an electrode comprising a mixed-ionic-electronic-conducting (MIEC) oxide having a surface and a basic oxide coating present on at least a portion of the surface of the MIEC oxide; and treating the electrode of the solid oxide fuel cell by vapor phase infiltration of a basic oxide.

One aspect of the disclosure herein is a method of preventing or treating chromia or silica poisoning of a mixed-ionic-electronic-conducting (MIEC) electrode, wherein the method comprises treating the MIEC electrode with an oxide infiltrant.

In one embodiment of the method disclosed herein, the MIEC electrode is a solid oxide fuel and electrolysis cell (SOFC/SOEC). In one embodiment of the method disclosed herein, the SOFC/SOEC operates at an intermediate temperature.

In one embodiment of the method disclosed herein, the oxide infiltrant comprises a binary oxide. In one embodiment of the method, the binary oxide is selected from the group consisting of Li₂O, CaO, and Gd₂O₃.

In one embodiment of the method disclosed herein, the oxide infiltrant comprises a nitrate. In one embodiment of the method, the nitrate comprises ammonium nitrate (NH₄NO₃), sodium nitrate (NaNO₃), or potassium nitrate (KNO₃)

In one embodiment of the method disclosed herein, the MIEC electrode comprises a perovskite. In one embodiment of the method, the perovskite is selected from the group consisting of (La,Sr)CoO3 (LSC), (La,Sr)(Co,Fe)O3 (LSCF), Sr(Ti,Fe)O3 (STF), (Sm,Sr)CoO3 (SSC), and (Ba,Sr)(Co,Fe)O3 (BSCF). In one embodiment of the method, the MIEC comprises fluorite-based Pr-substituted CeO₂ (PrₓCe₁₋ₓO_{2-δ}), preferably Pr_{0.1}Ce_{0.9}O_{2-δ} (PCO).

In one embodiment of the method disclosed herein, the MIEC comprises a grain size of about 1 μm, and a geometrically determined porosity of 26%.

In one embodiment of the method disclosed herein, the treating the electrodes by an oxide infiltrant comprises a surface treatment by a method selected from the group consisting of spin coating, chemical vapor deposition, molecular beam epitaxy (MBE), atomic layer deposition (ALD), sputtering, and pulse laser deposition (PLD).

In one embodiment of the method disclosed herein, the MIEC electrode is selected from the group consisting of bulk porous ceramics, screen printed thick film layers, electrolysis cells (SOEC), oxygen permeation membranes, oxygen storage materials, solar thermochemical reactors, metal oxide-based catalysts, and gas sensors.

In one embodiment of the method disclosed herein, the MIEC electrode comprises a semiconducting metal oxide (SMOX) sensor.

In one embodiment of the method disclosed herein, the method mitigates the effects of poisoning by chromia or silica.

In one embodiment of the method disclosed herein, the treating the MIEC electrode with an oxide infiltrant decreases the rate of degradation by chromia or silica to less than 0.2%/1,000 hours.

In one embodiment of the method disclosed herein, the treating the MIEC electrode with an oxide infiltrant maintains energy conversion of the MIEC electrode at levels of a pristine electrode.

In one embodiment of the method disclosed herein, the treating the MIEC electrode by coating active surfaces with the oxide infiltrant postpones initiation of degradation by chromia or silica.

In one embodiment of the method disclosed herein, the active surface of the MIEC electrode comprises a bulk porous ceramic or a screen-printed, thick film layer.

In one embodiment of the method disclosed herein, the active surface of the MIEC electrode comprises an active powder, thin film, or single crystal.

One aspect of the disclosure herein is a MIEC electrode treated by the method disclosed here. In one embodiment, the MIEC electrode comprises a perovskite.

One aspect of the disclosure herein is device for treating a MIEC electrode according to the methods disclosed herein. In one embodiment, the device uses a method selected from the group consisting of spin coating, chemical vapor deposition, molecular beam epitaxy (MBE), atomic layer deposition (ALD), sputtering, and pulse laser deposition (PLD).

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIGS. 1a-b: 1(a) Normalized conductivity relaxation profile in response to P_{O}_{₂} step (0.1 to 0.2 atm) beginning with a pristine Pr_{0.1}Ce_{0.9}O_{2-δ} specimen and following successive Cr- and Li-infiltration, measured at 400° C. 1(b) is an Arrhenius plot of log surface oxygen exchange coefficient (k_{chem}) vs reciprocal temperature. 1(c) is k_{chem} values obtained at 400° C. for pristine PCO followed by subsequent Cr- and Li-infiltrations, respectively. Inset of illustration below (c) shows the concentrations associated with the serial infiltrations of Cr (from 0.02 to 0.3 at %) and then Li (0.02 to 0.5 at %).

FIGS. 2a-b: (a) are k_{chem} values obtained at 500° C. of pristine PCO followed by subsequent Si- and Li-infiltrations. (b) are k_{chem} values obtained at 400° C. of pristine PCO followed by subsequent Si- and Ca-infiltrations.

FIGS. 3a-c: (a) is normalized conductivity relaxation profile in response to P_{O}_{₂} step (0.1 to 0.2 atm) beginning with a pristine Pr_{0.1}Ce_{0.9}O_{2-δ} specimen and following successive Li- and Cr-infiltration, measured at 400° C. (b) is an Arrhenius plot of log surface oxygen exchange coefficient (k_{chem}) vs reciprocal temperature. (c) are k_{chem} values obtained at 400° C. of pristine PCO followed by subsequent Li- and Cr-infiltrations, respectively.

FIGS. 4a-b: (a) is a normalized conductivity relaxation profile measured at 350° C. in response to P_{O}_{₂} step (0.1 to 0.2 atm) beginning with a pristine Pr_{0.1}Ce_{0.9}O_{2-δ} specimen followed by successive Ca- and Si-infiltration. (b) Comparison of k_{chem} values obtained at 350° C. of pristine PCO followed by subsequent Ca- and Si-infiltrations.

FIGS. 5a-h: (a) Schematic of procedure to sequentially infiltrate Cr- and Li-based nitrate solutions into Pr_{0.1}Ce_{0.9}O_{2-□} (PCO) porous specimen, electrode to enable conductivity relaxation measurements, following step changes in P_{O}_{₂}. Each infiltration level and the subsequent sum of infiltration levels are illustrated. Cross-sectional SEM images of (b) pristine PCO porous specimen and (c) following third serially infiltrated step of Cr and (d) following forth serially infiltrated step of Li. (e) Annular dark field (ADF) image (top) and Electron Energy Loss Spectroscopy (EELS) elemental mapping of Cr-M_{4,5} and Ce,Pr-L_{2,3} edge in Cr-infiltrated PCO (bottom). (f) EELS spectra around Cr-M_{4,5} (left), and O—K and Cr-L_{2,3} (right) edge in Cr-infiltrated PCO. (g) ADF image (left) and EELS elemental mapping of Cr-M_{4,5}, Ce,Pr-L_{2,3}, and Li—K edge in serially Cr- and Li-infiltrated PCO specimen (right). (h) EELS spectra of Cr-M_{4,5}/Li—K in serially Cr- and Li-infiltrated PCO specimen (black) and of Li—K edge in pure Li-infiltrated PCO (yellow) in the left panel. Right panel shows the O—K and Cr-L_{2,3} edge of serially Cr- and Li-infiltrated PCO specimen.

FIGS. 6a-b: (a) Normalized conductivity relaxation profiles in response to P_{O}_{₂} step (0.1 to 0.2 atm) for pristine PCO specimens with different thickness, LSC thin film and YSZ/Pt oxygen probe. (b) Oxygen surface exchange coefficients (k_{chem}) of PCO with different thickness as a function of temperature.

FIG. 7: Normalized conductivity relaxation profiles in response to P_{O}_{₂} step (0.1 to 0.2 atm) for the pristine PCO specimens sintered at 1450° C. and 1350° C. resulting in the same time constant (10 s).

FIGS. 8a-c: Electron Energy Loss Spectroscopy (EELS) elemental mapping of (a) Ce,Pr-L_{2,3} edge and Cr-M_{4,5} and in Cr₂O₃-infiltrated PCO. (b) Elemental mapping of Ce,Pr-L_{2,3}, and Li—K edge in Li₂O-infiltrated PCO. (c) Elemental mapping of Cr-M_{4,5} edge in serial infiltrated PCO.

FIG. 9: Evolution of the fitting parameters as a function of Cr loading level below 0.02 at %.

FIGS. 10a-h: Normalized conductivity relaxation profiles in response to P_{O}_{₂} step (0.1 to 0.2 atm) beginning with a pristine PCO specimen and following successive Cr- and Li-infiltration. (a) Pristine, (b) #1 Cr (0.02), (c) #2 Cr (0.1), (d) #3 Cr (0.3), (e) #4 Li (0.02), (f) #5 Li (0.1), (g) #6 Li (0.3) and (h) #7 Li (0.5). Unit in parentheses is at %. The profiles of (a-e) and (f-h) were fitted by the green (single time constant) and orange (two time constant) expressions, respectively.

FIG. 11: Activation energies (Eₐ) of k_{chem} of PCO porous specimen with serial infiltration using the Cr- and the Li-sources.

FIGS. 12a-b: (a) The overall conductivity (□) and (b) corresponding activation energies (Eₐ) of pristine PCO porous specimen with serial infiltration using Cr- and Li-sources.

FIGS. 13a-b: Temperature dependence of (a) resistance 2 (R2) and (b) 3 (R3) obtained from Nyquist plot of the pristine cell after Cr-infiltration and with subsequent Li-infiltration.

FIGS. 14a-b: Temperature dependence of (a) surface exchange resistance (R4) and (b) resistance of P1 of the pristine cell after Cr-infiltration and with subsequent Li-infiltration obtained from Nyquist plot and DRT, respectively.

FIG. 15. Oxygen dependence of capacitance 4 (C4) of the pristine cell after Cr-infiltration and with subsequent Li-infiltration obtained at 575° C. The data of Li-infiltration was extracted at 475° C. due to the limit of fitting at high temperatures.

### DETAILED DESCRIPTION

Some aspects of the present disclosure are related to modified electrodes, for example, for use in fuel cells. In some cases, the electrode may comprise a mixed-ionic-electronic-conducting (MIEC) oxide and a basic oxide. In some cases, the basic oxide may alter the electron density of the MIEC oxide and improve its catalytic performance, for example, like the oxygen reduction reaction. For instance, the catalytic performance of a MIEC oxide comprising a perovskite towards the oxygen reduction reaction (ORR) may be improved by using a basic oxide comprising CaO and/or Li₂O. Some aspects may be related to methods for applying basic oxides to electrodes comprising MIEC oxides. In some cases, applying the basic oxide before and/or when using the MIEC oxides within a fuel cell may be advantageous, as discussed in more detail elsewhere herein.

Catalytic reactions, such as the oxygen reduction reaction (e.g., ORR), are central to various technologies. Using appropriate catalysts may be advantageous for lowering the energy required to facilitate a chemical transformation (e.g., through a catalytic reaction). Ideal catalysts comprise cheap materials and facilitate the chemical transformation without significant energy lost. Typical catalysts, in some cases, are expensive (e.g., Pt). Moreover, some catalysts may be poisoned during use (e.g., MIEC oxides being poisoned by silica and/or chromia), which may effectively limit the catalyst's ability to lower the activation energy of the desired reaction. Accordingly, articles and methods related to improved catalysts are needed.

To this end, some aspects of the present disclosure are related to articles and methods comprising electrodes comprising MIEC oxides and basic oxides. In some such cases, the basic oxides may be present on a surface of the electrode and may alter the electron density of the MIEC oxide. Altering the electron density of the MIEC oxide may change important parameters of the electrode during catalytic reactions, for example the adsorption/desorption behavior of the species to be catalytically converted (e.g., O₂ during the ORR). In some cases, altering the electron density of the electrode may be improve the energy efficiency of the catalytic process.

Some aspects of the present disclosure are related to poisoned catalysts, for example, silica-poisoned MIEC oxides. Advantageously, it has been found that, in some embodiments, applying a basic oxide to a previously-poisoned catalyst may recover the activity of the catalyst. In some cases, applying the basic oxide may lead to a reaction between the basic oxide and the poisoning species, e.g., an acidic oxide, and may form a glassy and/or crystalline product oxide. Some such reactions may not be expected in solid-state systems due to relatively slow kinetics and/or thermodynamic barriers to forming reaction products (e.g., glassy and/or crystalline product oxides). As a non-limiting example, applying CaO to a silica-poisoned MIEC oxide may effectively neutralize the poisoning species and recover the initial activity of the MIEC oxide.

Disclosed herein is a method to recover the initial performance of poisoned materials by subsequent infiltration with oxides with controlled acidity, in some cases. Furthermore, the method disclosed here provides enhanced performance above that of the pristine specimen, in some cases. According to some embodiments, methods disclosed herein by systematic control of the relative acidity of the surface may provide the ability to optimize performance of a variety of devices as well as recover performance following poisoning of surfaces by species encountered during processing or during operation.

As used herein, “infiltration” is given its ordinary meaning in the art and a person of ordinary skill will understand its meaning. Generally, infiltration is to be understood to mean a species (e.g., a basic oxide) may integrate onto and/or into a host (e.g., the MIEC surface). In some cases, the species may be present on the surface of the host. According to some embodiments, the species may be distributed within at least a portion of the host (e.g., within a portion of a lattice and/or pores of the lattice). For example, in some cases, a basic oxide may be present on and/or within an MIEC oxide.

As used herein, “poisoning” is given its ordinary meaning in the art and a person of ordinary skill will know the metes and bounds of the term. Generally, poisoning in the context of an electrode and/or a catalyst refers to a change to the electrode and/or catalyst that results in a less active electrode and/or catalyst. For example, an electrocatalyst for the oxygen reduction reaction is poisoned when a change and/or process occurs to the electrode that results in the electrode requiring more energy to facilitate the oxygen reduction reaction than before the change and/or process occurred. In some embodiments, poisoning may refer to a change in electron density on the surface of the electrode. According to some embodiments, poisoning may refer to the blocking of active sites on the electrode surface. In accordance with some embodiments, the change and/or process occurring to the electrode may involve another species, for example, a species blocking the active sites of the electrode surface. In accordance with some embodiments, poisoning may refer to a combination of changing the electron density and blocking of active sites on the electrode surface. Other physical changes and/or processes can lead to poisoning of an electrode and/or a catalyst, the main point being that poisoning refers to any change and/or process that degrades the activity of the electrode and/or catalyst.

The Smith acidity scale for binary oxides can be used as a powerful descriptor for predicating their effect on the oxygen exchange coefficient (k_{chem}) of MIEC oxides. As a result, infiltration with binary oxides, ranging from strongly basic (Li₂O) to strongly acidic (SiO₂), onto the surface of Pr_{0.1}Ce_{0.9}O_{2-δ} (PCO), a chemically stable fluorite, free of inherent poison sources (e.g., segregated Sr), systematically varied k_{chem} over six orders of magnitude. Li₂O increased k_{chem} by nearly 1,000 times over that of pristine PCO, while SiO₂ depressed k_{chem} by nearly the same factor. Common poisons, e.g., Cr₂O₃ and SiO₂, happen to be acidic rather than basic, suggesting that this feature is likely the primary reason that these compounds serve to poison the ORR on SOFC cathodes. While Cr-species from metal interconnects have been regarded as a major cause of performance degradation in SOFCs, Si-species, is an even greater and ubiquitous poison commonly found in furnace refractories, sealants and associated with metal oxide processing. Not only can the Smith acidity be used to determine the influence of a single oxide additive, but the oxygen surface exchange rates could be tuned by orders of magnitude by selective choice of multiple oxide infiltrants. For example, we have been able to demonstrate that degradation initially caused by acidic additives (e.g., Cr₂O₃ and SiO₂) could be obviated by the subsequent addition of more basic species (e.g., Li₂O and CaO). To date, we have modified the surface chemistry of the active oxide surfaces or interfaces by infiltrating of nitrate salt solutions of the corresponding cations onto the surface of the MIEC, followed by calcination. Many alternate means for modifying the surface chemistry of an oxide surface exist including, for example, spin coating, chemical vapor deposition, molecular beam epitaxy (MBE), atomic layer deposition (ALD), sputtering, and pulse laser deposition (PLD). Furthermore, conversely, we have been able to demonstrate the ability to prevent and markedly postpone the initiation of degradation by, for example, the aforementioned Cr- and Si-based poisons, by pre-coating the pristine active surface with appropriate additives with controlled acidity. These methods were successfully used to pre-empt or reverse degradation by poisons in both bulk porous ceramics and screen-printed thick film layers. The same processing can be readily extended to include for example active powder, thin film, or single crystal surfaces.

The electrode may comprise an MIEC oxides comprise various materials, all of which by definition conduct both ions and electrons. In some cases, the electrode comprising an MIEC oxide may be referred to as an MIEC electrode. The mixed conducting properties of MIEC oxides may make them suitable for various applications, such as catalysts and/or functioning as electrodes. Non-limiting examples of MIEC oxides include strontium titanate (e.g. perovskite-based Fe-substituted SrTiO₃, SrTi₁₋ₓFeₓO₃), cerium oxide (e.g. fluorite-based Pr-substituted CeO₂, PrₓCe₁₋ₓO_{2-δ}, in some cases Pr_{0.1}Ce_{0.9}O_{2-δ}), lithium iron phosphate (LFP), other perovskites, and perovskite-related structures. In some cases, the MIEC oxide may comprise PCO and/or a perovskite. In some embodiments, it may be particularly advantageous when the MIEC oxide comprises a perovskite. In some such cases, the perovskite may comprise (La,Sr)CoO3 (LSC), (La,Sr)(Co,Fe)O3 (LSCF), Sr(Ti,Fe)O3 (STF), (Sm,Sr)CoO3 (SSC), and/or (Ba,Sr)(Co,Fe)O3 (BSCF).

According to some embodiments, the electrode structure may vary. In some cases, it may be advantageous for the electrode to comprise a microstructure comprising an average critical dimension shorter than the diffusion length of oxygen (˜1 micron). Accordingly, in some cases, the electrode may comprise a porous microstructure having a grain size of approximately 1 micron. In some cases, the surface of the MIEC oxide may comprise a bulk porous ceramic, a screen-printed, thick film layer, an active powder, a thin film, and/or a single crystal. In some cases, the electrode may be relatively porous. Porosity may be measured by any of a variety of suitable methods known to those of ordinary skill in the art. In some cases, the electrode may have a porosity of greater than or equal to 5%, greater than or equal to 10%, greater than or equal to 20%, or greater than or equal to 50%. In some embodiments, the electrode may have a porosity of less than or equal to 75%, less than or equal to 50%, less than or equal to 20%, or less than or equal to 10%. Combinations of the foregoing ranges are possible (e.g., greater than or equal to 20% and less than or equal to 50%).

It is to be understood that the term “oxide infiltrant” is used interchangeably in the present disclosure with the term “basic oxide.” Basic oxides may be associated with the MIEC materials, in accordance with some embodiments. In some cases, the basic oxides may be in electrical communication with the MIEC oxide, and accordingly may alter the electronic state (e.g., the electron density) of the MIEC oxide. According to some embodiments, electrical communication may be achieved by the basic oxide being present on at least a portion of the surface of the MIEC oxide. The basic oxide may be deposited on the MIEC oxide by any of a variety of suitable methods, for example, liquid infiltration, atomic layer deposition, chemical vapor deposition, molecular beam epitaxy (MBE), pulse laser deposition (PLD), spin coating, sputtering, and/or solution phase deposition.

The basic oxide may be any of a variety of suitable materials. In some cases, the basic oxide may comprise Li₂O, Na₂O, K₂O, La₂O₃, ZnO, SrO, Cs₂O, BaO, Gd₂O₃, Pr₂O₃, MgO, CoO, CeO₂, Fe₂O₃, Ga₂O₃, and/or CaO. According to some embodiments, it may be particularly advantageous when the basic oxide comprises CaO and/or Li₂O. In some cases, the basic oxide comprises CaO. The basic oxide comprises Li₂O, in accordance with some embodiments. In accordance with some embodiments, the metal of the basic oxide may be deposited on the MIEC oxide in the form of a nitrate (e.g., as a nitrate instead of an oxide, LiNO₃ instead of Li₂O). In some such cases, the MIEC oxide and the metal-nitrate may then be heated to relatively high temperatures (e.g., greater than 400, greater than or equal to 600, or other temperatures as disclosed elsewhere herein), wherein the nitrates decompose and the metals may oxidize (e.g., forming the basic oxide on the MIEC oxide). Non-limiting examples of nitrates include ammonium nitrate (NH₄NO₃), sodium nitrate (NaNO₃), and potassium nitrate (KNO₃).

In some cases, more than one basic oxide may be present on the surface of the MIEC oxide. In some such cases, each basic oxide may be present in equal amounts. In some cases, however, the more than one basic oxide may be present on the MIEC oxide surface in unequal amounts. For example, a ratio of a first basic oxide to a second basic oxide may be greater than or equal to 1:1, 2:1, 3:1, 4:1, 5:1, 6:1, 7:1, 8:1, 9:1 or 10:1. In some cases, the ratio may be less than or equal to 11:1, 10:1, 9:1, 8:1, 7:1, 6:1, 5:1, 4:1, 3:1, or 2:1. Combinations of the foregoing ranges are possible (e.g., greater than or equal to 1:1 and less than or equal to 5:1). Other ratios are also possible, as this disclosure is not so limited.

The basic oxide may interact with the MIEC oxide via a variety of forces, in accordance with some embodiments. In some cases, the basic oxide may bond with MIEC oxide, forming ionic bonds and/or covalent bonds. In some cases, the basic oxide may simply adhere to the MIEC oxide through intermolecular forces, such as Van der Waals forces, dipole-dipole interactions, and/or hydrogen bonding. In accordance with some embodiments, bonds and intermolecular forces may be present between the basic oxide and the MIEC oxide. In one set of embodiments, the basic oxide adheres to the MIEC oxide by only intermolecular forces. In another set of embodiments, the basic oxide forms ionic bonds with the MIEC oxide.

The basic oxide may be present on the MIEC oxide in any of a variety of suitable amounts, As long as an active fraction of the MIEC oxide is available for electrochemical reactions (e.g., The ORR). That is, the basic oxide may not be present conformally to enable electrochemical reactions to occur at the MIEC oxide surface. In some cases, the basic oxide may not be present on a majority of the MIEC oxide surface, and may be present in an amount to alter the electron density of the MIEC oxide but not significantly change the amount of active sites (e.g., where a species of interest may adsorb before electrochemical reaction occurs) available on the MIEC surface.

The basic oxide may be present in a variety of shapes and/or sizes. That is, in some cases, the basic oxide may be present as a plurality of particulates. In some embodiments, the basic oxide may form a continuous layer on the MIEC oxide with pinholes that expose the underlying MIEC oxide. According to some embodiments, the basic oxide may be present on the MIEC surface in islands, or sporadic depositions of semi-continuous conformal coatings. In some such cases, the basic oxide may be present a near conformal layer on the MIEC on some portions of the MIEC oxide, whereas on other portions of the MIEC oxide, the basic oxide may not be present or may be present in lower concentrations than in the conformal-layered sections.

Any of a variety of methods are suitable for determining the surface coverage of the basic oxide. In some cases, the surface coverage of the basic oxide is determined by measuring the volume of nitrogen gas adsorbed by the catalyst sample at various low-pressure levels, for example, by an ASTM D3663-20 standard test. For example, in some cases, the basic oxide may be present on less than or equal to 95%, less than or equal to 90%, less than or equal to 70%, less than or equal to 50%, less than or equal to 30%, less than or equal to 20%, less than or equal to 10%, less than or equal to 5%, less than or equal to 4.5%, less than or equal to 4%, less than or equal to 3.5%, less than or equal to 3%, less than or equal to 2.5%, less than or equal to 2%, less than or equal to 1.5%, less than or equal to 1.25%, less than or equal to 1%, less than or equal to 0.75%, less than or equal to 0.5%, less than or equal to 0.25%, less than or equal to 0.1%, less than or equal to 0.05%, or less than or equal to 0.01% of the MIEC oxide surface. In some embodiments, the basic oxide may be present on greater than or equal to 0.001%, greater than or equal to 0.01%, greater than or equal to 0.05%, greater than or equal to 0.1%, greater than or equal to 0.25%, greater than or equal to 0.5%, greater than or equal to 0.75%, greater than or equal to 1%, greater than or equal to 1.25%, greater than or equal to 1.5%, greater than or equal to 2%, greater than or equal to 2.5%, greater than or equal to 3%, greater than or equal to 3.5%, greater than or equal to 4%, or greater than or equal to 4.5%, greater than or equal to 5%, greater than or equal to 10%, greater than or equal to 20%, greater than or equal to 30%, greater than or equal to 50%, greater than or equal to 70%, or greater than or equal to 90% of the MIEC oxide surface. Combinations of the foregoing ranges are possible (e.g., greater than or equal to 3% and less than or equal to 5%). Other ranges are also possible.

The thickness of the basic oxide may vary, in accordance with some embodiments, and may be measured by an of a variety of suitable methods. In some cases, the thickness of the basic oxide may be determined by TEM analysis. In some cases, an average thickness of the basic oxide present on the MIEC oxide may be greater than or equal to 0.1 nm, greater than or equal to 0.5 nm, greater than or equal to 1 nm, greater than or equal to 1.5 nm, greater than or equal to 2 nm, greater than or equal to 2.5 nm, greater than or equal to 3 nm, greater than or equal to 3.5 nm, greater than or equal to 4 nm, or greater than or equal to 4.5 nm. In some embodiments, the average thickness of the basic oxide present on the surface of the MIEC oxide may be less than or equal to 5 nm, less than or equal to 4.5 nm, less than or equal to 4 nm, less than or equal to 3.5 nm, less than or equal to 3 nm, less than or equal to 2.5 nm, less than or equal to 2 nm, less than or equal to 1.5 nm, less than or equal to 1 nm, less than or equal to 0.5 nm, or less than or equal to 0.1 nm. Combinations of the foregoing ranges are possible (e.g., greater than or equal to 1 nm and less than or equal to 5 nm). Other ranges are also possible.

In some cases, the basic oxide is present on the surface of the MIEC electrode in an amount of less than or equal to 10⁻⁴ g/cm², less than or equal to 10⁻⁵ g/cm², less than or equal to 10⁻⁶ g/cm², less than or equal to 10⁻⁷ g/cm², less than or equal to 10⁻⁸ g/cm², less than or equal to 10⁻⁹ g/cm², or less than or equal to 10⁻¹⁰ g/cm². In some embodiments, the amount of basic oxide present is greater than or equal to 10⁻¹⁰ g/cm², greater than or equal to 10⁻⁹ g/cm², greater than or equal to 10⁻⁸ g/cm², greater than or equal to 10⁻⁷ g/cm², greater than or equal to 10⁻⁶ g/cm², greater than or equal to 10⁻⁵ g/cm², or greater than or equal to 10⁻⁴ g/cm². Combinations of the foregoing ranges are possible (e.g., greater than or equal to 10⁻¹⁰ g/cm² and less than or equal to 10⁻⁶ g/cm²). The amount of basic oxide present on the surface of the MIEC oxide may be calculated from the density of the host MIEC oxide, the density of the basic oxide, the loading of the basic oxide, and the grain size of the host.

According to some embodiments, it may be advantageous if the basic oxide may have a relatively low vapor pressure. For example, in some cases, a solid oxide fuel cell comprising an electrode comprising of basic oxide may be heated to a relatively high temperature during operation as disclosed elsewhere herein. In some such cases, the basic oxide having a relatively low vapor pressure may prevent the basic oxide from evaporating and/or otherwise degrading when heated to relatively high temperatures. In accordance with some embodiments, the basic oxide may have a vapor pressure less than or equal to 10⁻⁸ kPa, less than or equal to 10⁻⁹ kPa, less than or equal to 10⁻¹⁰ kPa, less than or equal to 10⁻¹¹ kPa, less than or equal to 10⁻¹² kPa, or less than or equal to 10⁻¹³ kPa when heated to a temperature of 800° C.

As mentioned above, the vapor pressure of the basic oxide may be important, for example, within a solid oxide fuel cell. In some such cases, an electrode comprising an MIEC oxide and a basic oxide may be heated to any of a variety of temperatures during processing and/or when operating within the fuel cell. In some cases, the basic oxide may be heated to temperatures greater than or equal to 500° C., greater than or equal to 600° C., greater than or equal to 700° C., greater than or equal to 800° C., greater than or equal to 900° C., greater than or equal to 1000° C., greater than or equal to 1100° C., greater than or equal to 1200° C., greater than or equal to 1300° C., greater than or equal to 1400° C., greater than or equal to 1500° C., or greater than or equal to 1600° C. during processing and/or when operating within the fuel cell. In some embodiments, the basic oxide may be heated to temperatures less than or equal to 1600° C., less than or equal to 1500° C., less than or equal to 1400° C., less than or equal to 1300° C., less than or equal to 1200° C., less than or equal to 1100° C., less than or equal to 1000° C., less than or equal to 900° C., less than or equal to 800° C., less than or equal to 700° C., less than or equal to 600° C., or less than or equal to 500° C. during processing and/or when operating within the fuel cell. Combinations of the foregoing ranges are possible (e.g., greater than or equal to 800° C. and less than or equal to 1400° C., greater than or equal to 500° C. and less than or equal to 1000° C.). Other ranges are also possible.

According to some embodiments, after fabrication and/or after integration and operation within a fuel cell, an electrode may comprise a basic oxide. In some cases, the electrode may further comprise an acidic oxide. That is, in some cases, acidic oxide may be present on the surface of the electrode. In some cases, the acidic oxide and the basic oxide may both present on the surface of the electrode. In accordance with some embodiments, the basic oxide may be present on at least a portion of the surface of the electrode, for example, after the basic oxide is deposited on the surface of the electrode. In some cases, as discussed elsewhere herein, the acidic oxide may be present on the surface after operating the fuel cell and/or after exposing the fuel cell to a source of the acidic oxide.

In some cases, the basic oxide, in the presence of the acidic oxide, may react and form a glassy and/or crystalline product oxide. It is to be understood that when the term glassy and/or crystalline product oxide is used, it may refer to a glassy product oxide, a crystalline produce oxide, or a combination comprising a glassy and a crystalline product oxide. In some cases, the basic oxide, in the presence of the acidic oxide, may react and form a glassy and/or crystalline product oxide. In some cases, it may be advantageous when the basic oxide and the acidic oxide react to form a glassy and/or crystalline product oxide. That is, in some cases, the reaction may ensure that the acidity (e.g., electron withdrawing property) of the acidic oxide does not degrade the activity of the MIEC oxide relative to an MIEC oxide without an acidic oxide or basic oxide. In some cases, the glassy and/or crystalline product oxide may comprise an acidic oxide, a basic oxide, and/or an MIEC oxide. In some embodiments, the glassy and/or crystalline product oxide comprises Ca, Li, Si, Cr, and/or O. As a non-limiting example, the basic oxide may comprise CaO and the acidic oxide may comprise Cr₂O₃, both of which may react to form a glassy and/or crystalline product oxide comprising CaCrO₄. In some such cases, the Ca and the Cr of the precursor basic and acidic oxides may be collocated, which may be detected by, for example, by EELS.

According to some embodiments, the reaction between the acidic and basic oxides may only proceed at relatively high temperatures due to relatively slow reaction kinetics. In some cases, the reaction to form the glassy and/or crystalline product oxide only proceeds when the basic oxide and the acidic oxide present on the surface of the MIEC oxide are heated to a temperature of greater than or equal to 100° C., greater than or equal to 200° C., greater than or equal to 300° C., greater than or equal to 400° C., greater than or equal to 500° C., greater than or equal to 600° C., greater than or equal to 700° C., greater than or equal to 800° C., greater than or equal to 900° C., or greater than or equal to 1000° C. In some embodiments, the reaction only proceeds when heated to a temperature less than or equal to 1000° C., less than or equal to 900° C., less than or equal to 800° C., less than or equal to 700° C., less than or equal to 600° C., less than or equal to 500° C., less than or equal to 400° C., less than or equal to 300° C., or less than or equal to 200° C. Combinations of the foregoing ranges are possible (e.g., greater than or equal to 400° C. and less than or equal to 800° C.). Other ranges are also possible.

As disclosed elsewhere herein, the presence of the acidic oxide may degrade the oxygen exchange kinetics of the MIEC oxide, in some cases. Accordingly, the presence of the acidic oxide is undesirable, in some cases, but may accumulate due to normal operating procedures during applications, for example, using a fuel cell comprising the electrodes disclosed herein. The accumulation rate of the acidic oxide may be relatively low, in accordance with some embodiments. In some cases, the accumulation rate of the acidic oxide on the surface of the MIEC oxide during use in a fuel cell may be greater than or equal to 0.01 at %, greater than or equal to 0.05 at %, greater than or equal to 0.1 at %, greater than or equal to 0.2 at %, greater than or equal to 0.3 at %, or greater than or equal to 0.4 at % relative to the MIEC surface per 1000 hours of operation. In some embodiments, the accumulation rate of the acidic oxide on the surface of the MIEC oxide may be less than or equal to 0.5 at %, less than or equal to 0.4 at %, less than or equal to 0.3 at %, less than or equal to 0.2 at %, less than or equal to 0.1 at %, or less than or equal to 0.05 at % relative to the MIEC surface per 1000 hours of operation. Combinations of the foregoing ranges are possible (e.g., greater than or equal to 0.01 at % and less than or equal to 0.05 at %). Other ranges are also possible

In some cases, when the basic oxide is present, some or all of the acidic oxide may react with the basic oxide as it accumulates. According to some embodiments, essentially all of the acidic oxide may react with the basic oxide as long as there is stoichiometrically more basic oxide present on the surface of the MIEC oxide than the accumulated acidic oxide. To this end, the amount of glassy and/or crystalline product oxide present on the surface of the MIEC oxide may be limited by the accumulation rate of the acidic oxide and the usage time of the electrode comprising the MIEC oxide, for example, when operating a fuel cell.

In some cases, the glassy and/or crystalline product oxide may be present on the surface of the MIEC oxide in an amount of greater than or equal to 0.001 at %, greater than or equal to 0.005 at %, greater than or equal to 0.01 at %, greater than or equal to 0.02 at %, greater than or equal to 0.03 at %, greater than or equal to 0.04 at %, greater than or equal to 0.05 at %, greater than or equal to 0.06 at %, greater than or equal to 0.08 at %, greater than or equal to 0.1 at %, greater than or equal to 0.2 at %, greater than or equal to 0.3 at %, greater than or equal to 0.4 at %, greater than or equal to 0.5 at %, greater than or equal to 0.8 at %, greater than or equal to 1 at %, greater than or equal to 1.5 at %, greater than or equal to 2 at %, greater than or equal to 2.5 at %, greater than or equal to 3 at %, greater than or equal to 4 at %, or greater than or equal to 5 at %, relative to the MIEC surface. In some embodiments, the glassy and/or crystalline product oxide may be present in an amount of less than or equal to 5 at %, less than or equal to 4 at %, less than or equal to 3 at %, less than or equal to 2.5 at %, less than or equal to 2 at %, less than or equal to 2 at %, less than or equal to 1.5 at %, less than or equal to 1 at %, less than or equal to 0.8 at %, less than or equal to 0.5 at %, less than or equal to 0.4 at %, less than or equal to 0.3 at %, less than or equal to 0.2 at %, less than or equal to 0.1 at %, less than or equal to 0.08 at %, less than or equal to 0.06 at %, less than or equal to 0.05 at %, less than or equal to 0.04 at %, less than or equal to 0.03 at %, less than or equal to 0.02 at %, less than or equal to 0.01 at %, or less than or equal to 0.005 at %, relative to the MIEC surface. Combinations of the foregoing ranges are possible (e.g., greater than or equal to 0.01 at % and less than or equal to 0.05 at %). Other ranges are also possible. Some of the amounts for the glassy and/or crystalline product oxide are present on the surface of the MIEC oxide after the MIEC electrode has been heated to a relatively high temperature (e.g., greater than or equal to 400° C., or other temperatures as disclosed elsewhere herein) for a relatively long time (e.g., greater than or equal to 1 hour, greater than or equal to 10 hours, greater than or equal to 100 hours, greater than or equal to 1000 hours, greater than or equal to 5000 hours, greater than or equal to 10000 hours, or greater than or equal to 20000 hours, etc.), for example, during use as a cathode material in a in a fuel cell.

In some cases, as disclosed elsewhere herein, the electrode comprising an MIEC oxide and a basic oxide may be suitable for use in a fuel cell. In some cases, the presence of the basic oxide on the MIEC oxide may improve the performance of the MIEC oxide within the fuel cell and/or may prevent the degradation For example, in some cases, using an electrode comprising an MIEC oxide and a basic oxide may improve the energy efficiency of the fuel cell by greater than or equal to 0.1%, greater than or equal to 0.2%, greater than or equal to 0.3%, greater than or equal to 0.4%, greater than or equal to 0.5%, greater than or equal to 0.6%, greater than or equal to 0.8%, greater than or equal to 1%, greater than or equal to 1.2%, greater than or equal to 1.5%, greater than or equal to 2%, greater than or equal to 2.5%, greater than or equal to 3%, greater than or equal to 4%, greater than or equal to 5%, greater than or equal to 8%, greater than or equal to 10%, greater than or equal to 15%, greater than or equal to 25%, or greater than or equal to 50%, relative to an substantially identical electrode without the basic oxide. In some embodiments, using an electrode comprising an MIEC oxide and a basic oxide may improve the energy efficiency of the fuel cell by less than or equal to 50%, less than or equal to 25%, less than or equal to 20%, less than or equal to 15%, less than or equal to 10%, less than or equal to 8%, less than or equal to 5%, less than or equal to 4%, less than or equal to 3%, less than or equal to 2.5%, less than or equal to 2%, less than or equal to 1.5%, less than or equal to 1.2%, less than or equal to 1%, less than or equal to 0.8%, less than or equal to 0.6%, less than or equal to 0.5%, less than or equal to 0.4%, less than or equal to 0.3%, or less than or equal to 0.2%, relative to an substantially identical electrode without the basic oxide.

In some cases, when using an electrode comprising an MIEC oxide and a basic oxide, the fuel cell may be operated for greater than or equal to 1 hour, greater than or equal to 5 hours, greater than or equal to 10 hours, greater than or equal to 20 hours, greater than or equal to 50 hours, greater than or equal to 100 hours, greater than or equal to 1000 hours, greater than or equal to 5000 hours, greater than or equal to 10000 hours, or greater than or equal to 20000 hours without replacing the electrode. In some embodiments, the fuel cell may be operated for less than or equal to 20000 hours, less than or equal to 15000 hours, less than or equal to 10000 hours, less than or equal to 5000 hours, less than or equal to 1000 hours, less than or equal to 100 hours, less than or equal to 50 hours, less than or equal to 20 hours, less than or equal to 10 hours, or less than or equal to 5 hours without replacing the electrode. Combinations of the foregoing ranges are possible (e.g., greater than or equal to 1000 hours and less than or equal to 5000 hours). Other ranges are also possible.

In some cases, during relatively long operating times of the fuel cell, a conventional electrode may be gradually poisoned and thus lose performance efficiency (e.g., lower power output density). As disclosed elsewhere, in some cases, the accumulation of an acidic oxide on the surface an electrode may result in the poisoning of the electrode. In accordance with some embodiments, fuel cells may exhibit an efficiency loss of greater than or equal to 5%, greater than or equal to 10%, greater than or equal to 20% (e.g., they no longer efficiency facilitate the reaction of interest) per 1000 hours of operation.

Advantageously, in some embodiments, when the basic oxide is present on the surface of the MIEC oxide of the electrode, using the electrode in the fuel cell may lead to the fuel cell exhibiting a relatively lower efficiency loss than when using an electrode that does not have a basic oxide. For example, when using an electrode comprising an MIEC oxide and a basic oxide in the fuel cell, the fuel cell may exhibit an efficiency loss of greater than or equal to 0.1%, greater than or equal to 0.5%, greater than or equal to 1%, greater than or equal to 2%, greater than or equal to 3%, or greater than or equal to 4% per 1000 hours of operation. According to some embodiments, the fuel cell may exhibit an efficiency loss of less than or equal to 5%, less than or equal tot 4%, less than or equal to 3%, less than or equal to 2%, less than or equal to 1%, or less than or equal to 0.5% per 1000 hours of operation. Combinations of the foregoing ranges are possible (e.g., greater than or equal to 1% and less than or equal to 2% per 1000 hours). Other ranges are also possible. That, in some cases, the basic oxide may postpone the degradation of the MIEC oxide by poisoning (e.g., via introduction of an acidic oxide). Accordingly, in some such cases, the fuel cell comprising the MIEC oxide may not experience an efficiency loss over a time of greater than or equal to 10 hours, greater than or equal to 100 hours, greater than or equal to 500 hours, greater than or equal to 1000 hours, greater than or equal to 2000 hours, greater than or equal to 5000 hours, greater than or equal to 10000 hours, or greater than or equal to 20000 hours.

In some embodiments, the basic oxide present on the MIEC oxide may gradually react with acidic oxide as the acidic oxide accumulates during fuel cell operation. Accordingly, at long times (e.g., greater than or equal to 100 hours, greater than or equal to 1000 hours, greater than or equal to 10000 hours, or longer operation times), all of the basic oxide may react with acidic oxide and yield a MIEC oxide that no longer has a basic oxide on its surface. In some such cases, the electrode in the fuel cell (e.g., that no longer has a basic oxide on its surface) may exhibit a relatively higher efficiency loss rate, lower performance efficiency (e.g., relative to when the basic oxide is present), and/or not be operation for relatively long times. According to some such embodiments, it may be advantageous to further deposit more basic oxide on the surface of the MIEC oxide in the fuel cell to recover the efficiency, improve efficiency and/or relatively lower the rate of efficiency loss. Redepositing the basic oxide on the MIEC oxide of the electrode while the electrode is within a fuel cell may be achieved by vapor phase infiltration, such as chemical vapor deposition and/or atomic layer deposition. In this manner, the basic oxide may be periodically replenished (e.g., within every 1000 hours, within every 10000 hours, or within every 20000 hours) to prevent poisoning by acidic oxides, thereby limiting the need to replace the electrode comprising the MIEC oxide, and thereby the full solid oxide fuel cell stack, as often.

In accordance with some embodiments, the basic oxide may be deposited on the MIEC oxide before the MIEC oxide is integrated within a fuel cell. In some such cases, the presence of the basic oxide provides the beneficial properties disclosed elsewhere herein. In some embodiments, the basic oxide maybe deposited on the MIEC oxide after the MIEC oxide has been integrated within a fuel cell and/or the fuel cell has been operated. In some such cases, the MIEC oxide comprises the basic oxide before being integrated within the fuel cell. In other such cases, however, the MIEC oxide does not comprise the basic oxide before being integrated within the fuel cell. In some cases, depositing the basic oxide on the surface of the MIEC oxide after the MIEC oxide has been integrated within the fuel cell may enable the treatment of the MIEC oxide in situ, for example, once the fuel cell is operating and may be exposed to acidic oxides (e.g., chromia and/or silica) that may poison the MIEC oxide. In situ deposition of the basic oxide onto a surface of an MIEC electrode that is integrated within a fuel cell may be accomplished by vapor phase deposition (e.g., chemical vapor deposition and/or atomic layer deposition), in some embodiments.

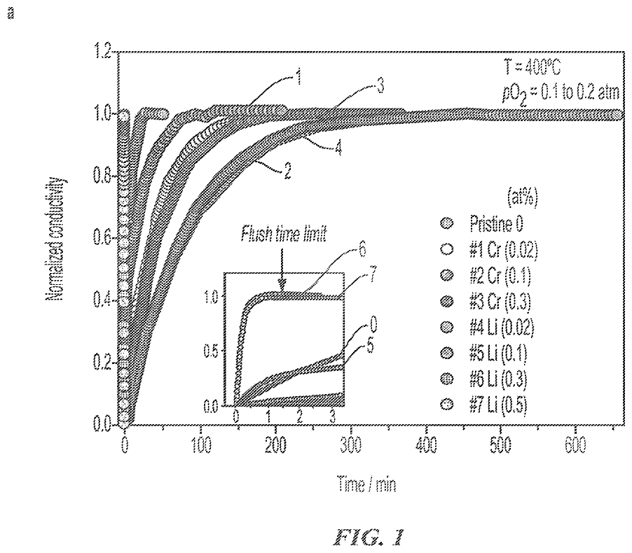

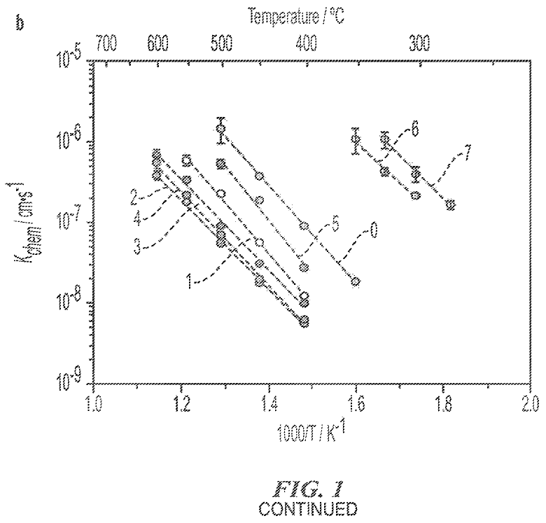

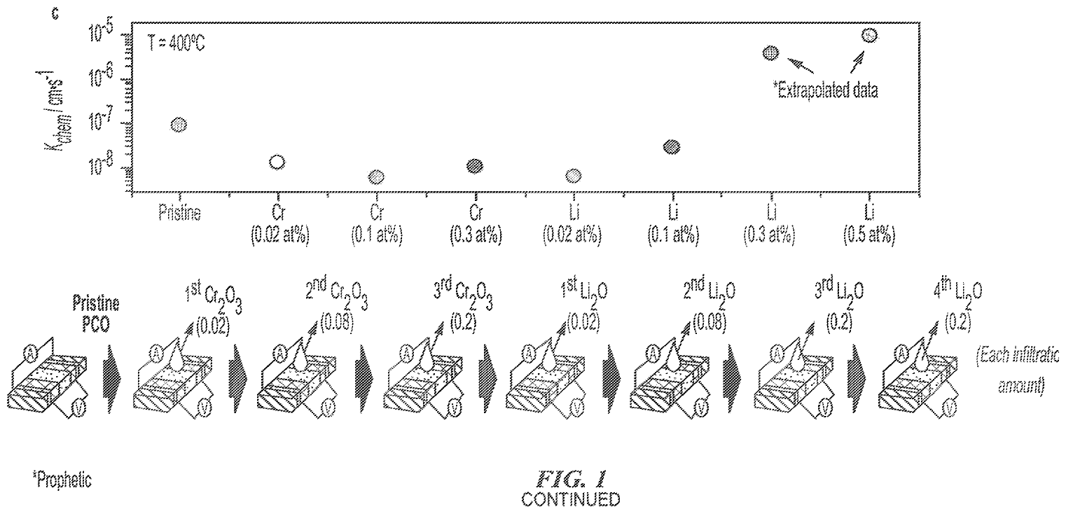

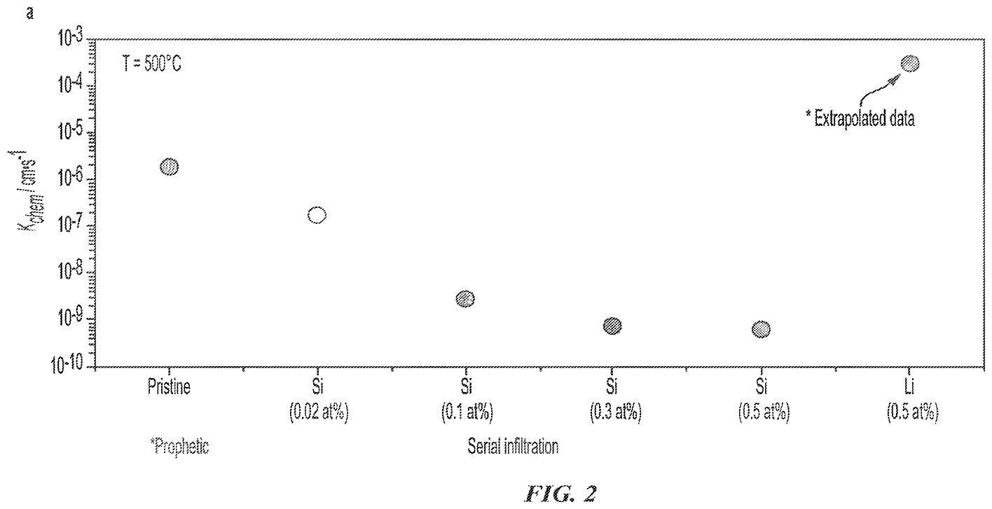

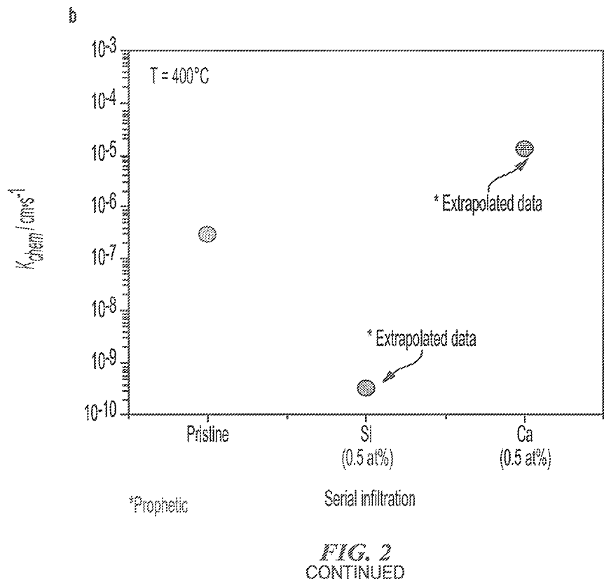

### The Addition of a Basic Material to a Metal Oxide Surface Degraded by Acidic Species is Demonstrated to Reactivate Degraded Devices. (FIGS. 1 and 2)

Chromia (e.g., an acidic oxide) was found to have a deleterious effect on the performance of a model mixed ionic electronic conducting (MIEC) oxide Pr_{0.1}Ce_{0.9}O_{2-δ} (PCO, a cathode material), as presented in FIG. 1. Note that prophetic data in FIG. 1 and the remaining FIGS. is extrapolated from the trends observed in the collected data. The oxygen exchange coefficient (k_{chem}) is a measure of the oxygen exchange rate between the solid and gas phase. FIG. 1 shows k_{chem} as a function of surface Cr₂O₃ loading via both electrical conductivity transient measurements and area-specific resistance (ASR) of an electrochemical cell (measured with the aid of electrochemical impedance spectroscopy). FIG. 1 shows that the oxygen exchange rate, k_{chem}, was found to decrease ca. 20-fold while the ASR increased ca. 10-fold, respectively, with Cr₂O₃ loading while maintaining the same activation energy, confirming the poisoning effect of Cr₂O₃ on the oxygen reduction reaction at the surface of the PCO. These are key figures of merit for the performance of SOFC cathodes. Subsequent serial infiltration with a Li-source not only recovered the initial k_{chem} and ASR values of the MIEC oxides, but enhanced the figures of merit beyond the properties of the non-infiltrated PCO specimen. An enhancement of k_{chem} by more than three orders of magnitude and a reduction in ASR by a factor of 50 were demonstrated. Accordingly, in some cases, recovering and/or enhancing the oxygen exchange coefficient of the MIEC oxide (e.g., the PCO in this example) may regenerate the performance (e.g., the power output density) of a solid oxide fuel cell whose performance (e.g., power output density) has deteriorated over time due to poisoning. This may be advantageous because, instead of discarding the fuel cell, the lifetime of the fuel cell may be extended and lead to, for example, improved levelized cost of electricity or energy (LCOE).

While an acidic oxide comprising chromia may be present in SOFC technology, another acidic oxide comprising silica may also be present. Silica is a more ubiquitous poison source than chromia and may be an issue in a wider range of applications. For example, FIG. 2 illustrates how acidic SiO₂ (e.g., silica) may degrade the oxygen exchange rate of MIEC oxides and how Li₂O and/or CaO may be used to recover activity of the MIEC oxide after poisoning. As demonstrated, SiO₂ infiltration results in a nearly 4,000-fold depression in k_{chem} as compared to that of pristine PCO (e.g., no acidic or basic oxide). Subsequent serial infiltration with Li₂O and CaO additives serve not only to recover the Si-degraded kinetics, but further improve performance over that of the initial pristine material. FIG. 2 shows the Li₂O and CaO additives accelerate the oxygen exchange kinetics of the SiO₂-poisoned device by over five and four orders of magnitude, respectively. This further shows that basic oxides such as Li₂O and CaO may be used to recover and regenerate at poisoned device (e.g., an electrode comprising an MIEC oxide that is poisoned by an acidic oxide).

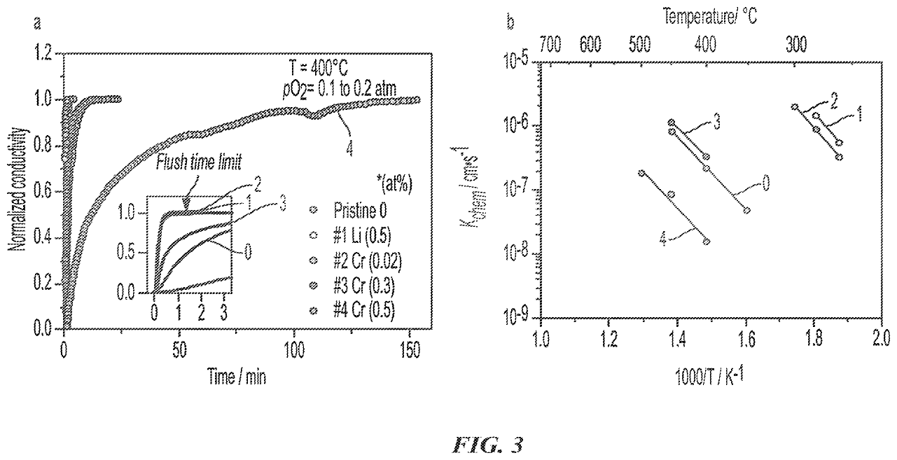

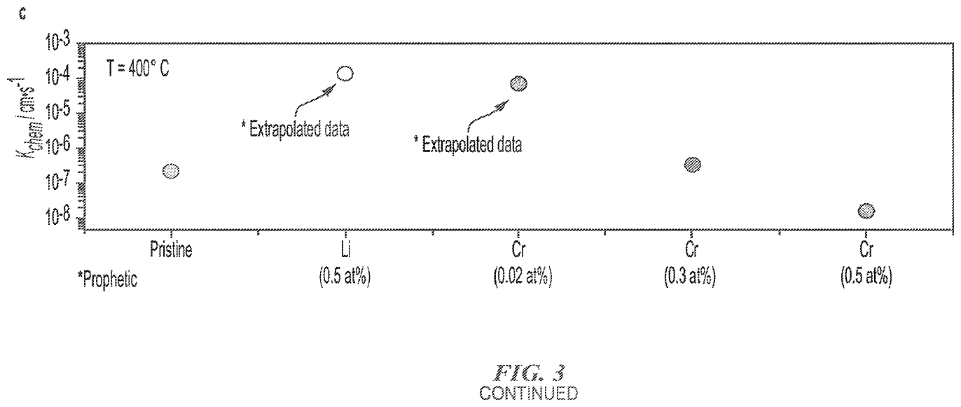

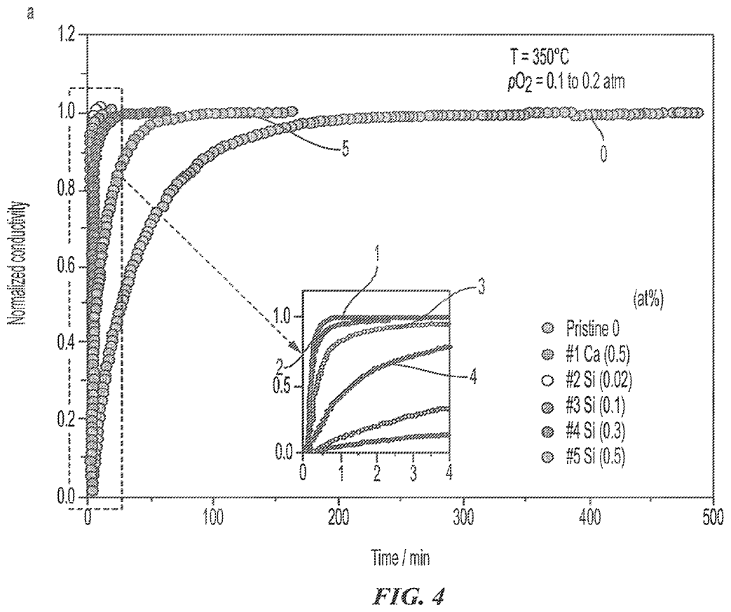

Pretreatment of Metal Oxide Surfaces with Appropriate Oxide Additives Serve to Fully Block or Markedly Delay the Onset of Degradation Due to the Presence of Common Surface Poisons, Leading to Marked Enhancements in Long-Term Stability. (FIGS. 3 and 4)

Another approach to alleviate poisoning induced by acidic additives by pre-treatment of the respective surfaces with appropriate additives is disclosed herein. In some cases, pre-treating the MIEC oxide with a basic oxide may prevent and/or minimize subsequent poisoning of the surface of the MIEC oxide by acidic oxides. For example, FIG. 3 shows that the oxygen exchange coefficient (k_{chem}) of the pristine material may be increased by three orders of magnitude by applying a basic oxide to the pristine material (e.g., Li-infiltration) at a level of 0.5 at %. Subsequent Cr-infiltration at 0.02 at % did not significantly lower k_{chem} values. This high tolerance against Cr-poisoning was maintained despite continued serial Cr-infiltrations of up to a high concentration of 0.3 at %. This resistance to poisoning is important because poisoning may proceed at rates such as 0.1 at % Cr loading after 3,000 hrs of stack operation, which as shown in FIG. 1 is sufficient to significantly deteriorate the performance of a MIEC oxide without a basic oxide applied. Such pretreatments thus enable active SOFC devices to remain robust and active over extended lifetimes, relative to substantially identical, untreated SOFCs.

FIG. 2 shows that initial Si-infiltration onto the surface of our devices led to nearly a 4,000-fold drop in k_{chem} values. However, as demonstrated in FIG. 4, initially applying (e.g., infiltrating and/or depositing) CaO onto the surface of a pristine PCO may both improve the oxygen exchange rate of the PCO and provide a tolerance to potential subsequent Si-induced degradation. For example, the initial Ca-infiltration is demonstrated to boost the rate of oxygen exchange of PCO by more than two orders of magnitude. The following Si-infiltration to the high concentration of 0.5 at % (e.g., which led to a 4000-fold decrease in the k_{chem} in FIG. 2) still maintained an improved performance relative to the pristine PCO (e.g., without any additives). This finding promises significant improvements in performance, coupled with markedly reduced degradation rates, and much longer lifetimes. Importantly, the results of FIGS. 1-2 show that the application of a basic oxide may recover the initial oxygen exchange rate of a poisoned MIEC oxide, whereas FIGS. 3-4 show basic oxides may be used to pre-treat MIEC oxides and effectively prevent subsequent poisoning of the MIEC oxides. Both results, in some cases, may improve fuel cell performance and/or reduce degradation rates of the MIEC oxide in the fuel cell, which may extend the lifetime of the MIEC oxide and/or fuel cell. Advantageously, the latter result based on surface pretreatment and disclosed in FIGS. 3-4 may further obviate and/or delay the need for subsequent surface treatments, thereby reducing maintenance costs of the fuel cell and/or lead to markedly improved LCOE.

In some cases, either pretreatment of surfaces with appropriate additives or post treatment following poisoning by oxides such as chromia or silica would serve to significantly extend the lifetimes of a variety of devices, such as solid oxide fuel/electrolyzer cells, permeation membranes and various catalytic converters. This would serve to substantially lower the LCOE of such devices and thereby lead to more rapid scale-up of these critical technologies in support of society's critical need to introduce more efficient and cleaner energy conversion and storage systems, in some embodiments.

What is disclosed herein is how the addition of a basic infiltrate affects surface oxygen exchange kinetics degraded by Cr poisoning. The electrical conductivity of mixed conducting oxides varies with oxygen stoichiometry, e.g., with variation in the surrounding oxygen partial pressure. By monitoring the electrical conductivity transient after a rapid step change in oxygen partial pressure, the kinetics associated with the uptake or release of oxygen by the oxide can be determined.

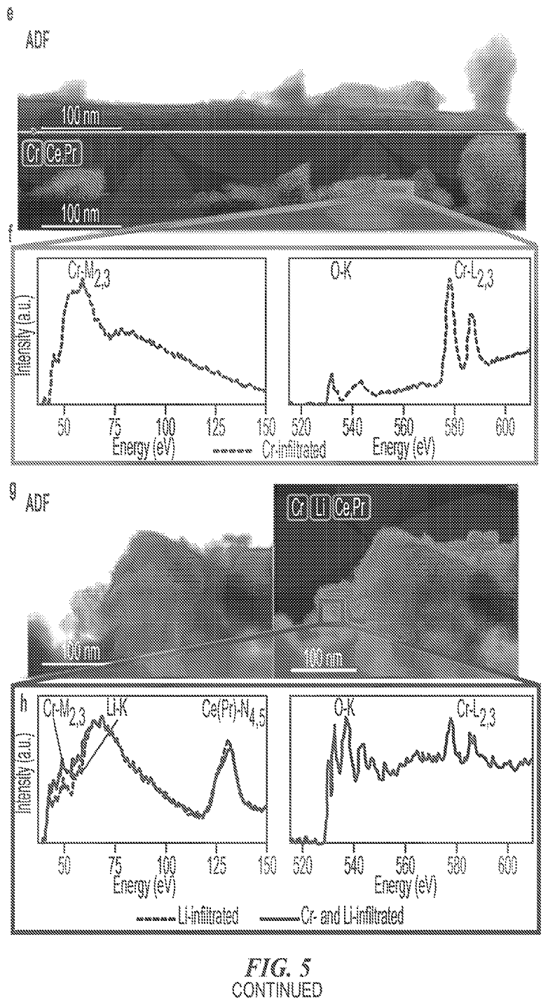

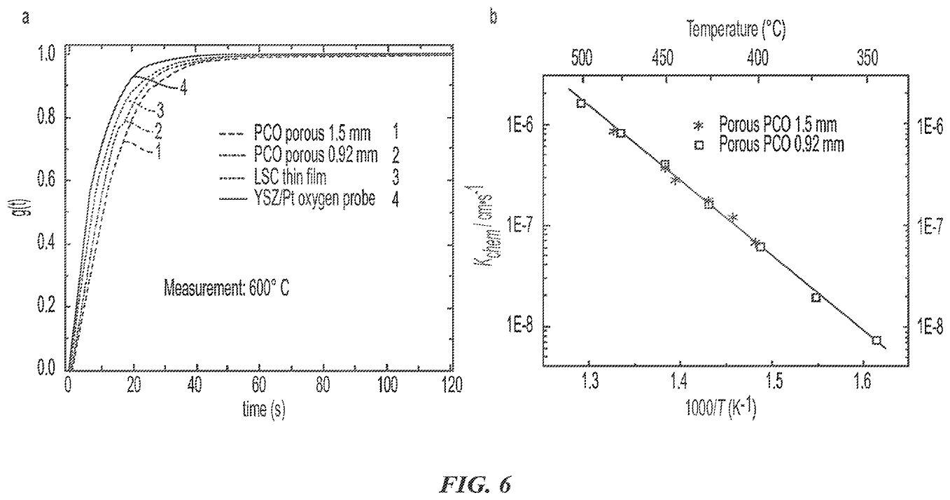

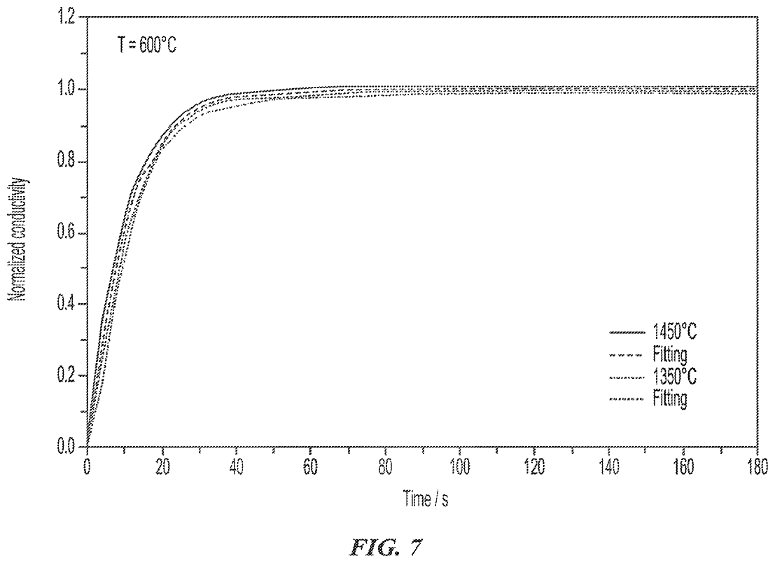

There are a number of factors to consider to correctly interpret the electrical conductivity relaxation measurements in porous specimen, in some cases. For example, gas phase diffusion inside the pores and/or bulk oxygen diffusion within the solid may impact the kinetics, and thus these must be accounted for so that only the surface oxygen exchange kinetics are limiting during the electrical conductivity relaxation measurements. To this point, overall kinetics of the prepared porous PCO specimen are not limited by gas phase diffusion inside the pores under the measurement conditions (see Table 1 and FIGS. 6 and 7). That is, while the oxygen equilibration kinetics in general depend on both bulk oxygen diffusivity and the surface exchange reaction, selecting a microstructure characterized by a physical oxygen diffusion length (˜1 μm based on grain size) much shorter than the critical thickness of PCO (3.6×10³ μm at 670° C., above which bulk oxygen diffusion becomes dominant) readily ensures that the reduction/oxidation kinetics are solely determined by surface oxygen exchange. Thus, a porous specimen of PCO with a grain size of approximately 1 μm and a geometrically determined porosity of 26% was selected to ensure surface limited oxygen exchange kinetics.

In some such cases, an additional benefit is that the PCO surface may be easily infiltrated with ethanol-based solutions of Cr(NO₃)₃ and LiNO₃. The nitrates may fully decompose following in situ calcination in synthetic air at 600° C., leaving the Cr- and/or Li-based oxides on the surface. The PCO specimen is measured once, prior to infiltration, to provide a reference data set of k_{chem}. Then, the specimen is infiltrated with chromia, starting with low loading (0.02 at % with respect to PCO) and k_{chem} is re-measured. In order to determine the dependence of the degradation level on Cr-concentration, the infiltration was repeated three times to increase Cr loading incrementally (up to 0.3 at %). The sample was re-measured by conductivity relaxation following each subsequent infiltration. In an attempt to reactivate the exchange rate of oxygen, the same porous PCO specimen was then infiltrated a total of four additional times (up to 0.5 at %) with Li-species and measured after each infiltration step.

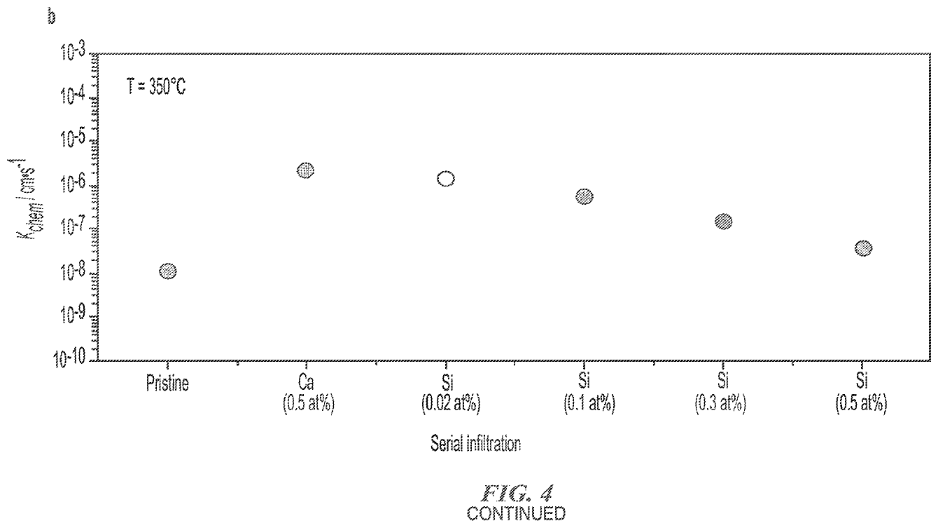

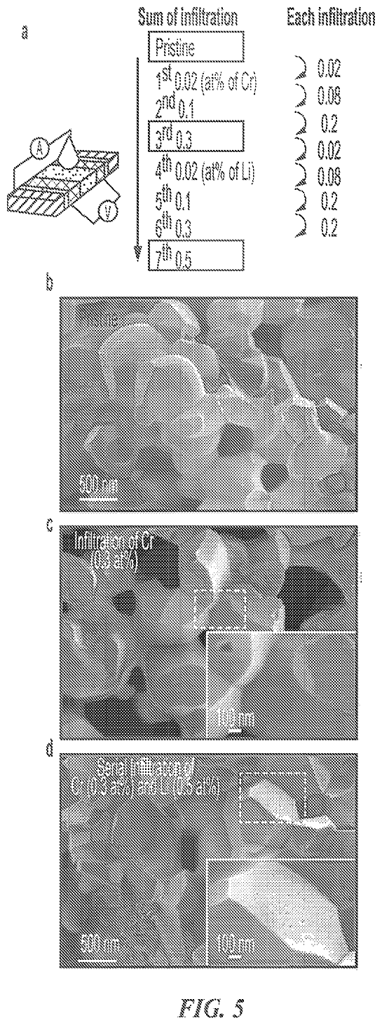

A schematic illustrating the sequence of infiltrations of chrome- and lithium-based nitrate solutions into the porous PCO specimen is shown in FIG. 5a, with the infiltration notation used hereafter described as the sum of the infiltration amount. In the low-resolution scanning electron microscopy (SEM) images, no significant microstructural change of the PCO specimen was observed following all seven infiltration steps (e.g., see FIGS. 5b-5d). In order to gain more detailed chemical information about surface chemistry and to examine the structure of the additives, scanning transmission electron microscopy with electron energy loss spectroscopy (STEM-EELS) was used. The energy loss near-edge fine structure (ELNES) is based on the number of unoccupied states and highly dependent on the local chemical environment that creates a unique “fingerprint” for each element and phase that is used to determine the spatial distribution of atomic species. FIG. 5e and FIG. 8 present an image of the 0.3 at % Cr-infiltrated PCO surface. The top panel shows the annular dark field (ADF) image and bottom the elemental mapping of Cr-rich regions and PCO regions. The spectra for the Cr-M_{2,3} and O—K and Cr-L_{2,3} edges are shown in FIG. 5f. Based on the EELS white-line ratios between Cr-L₂ and Cr-L₃, the Cr-rich regions are crystalline Cr₂O₃ (alpha). This indicates, in line with the image (see FIG. 5c), that the infiltration forms Cr₂O₃ crystallites on the surface of PCO that have an average maximum cross-sectional on the scale of tens of nm. In the case of perovskite electrodes, in addition to the formation of Cr₂O₃ crystallites, authors often report the formation of chromates with intrinsic poisons, e.g., segregated Sr on the surface.

In the images of the 0.5 at % Li-infiltrated PCO surface (FIG. 5d), no crystalline Li₂O phase is visible. Instead, the Li-species is finely dispersed on the PCO surface. The spectra taken of the pure Cr- and Li-infiltrated PCO specimens will be used as a reference for the serial Cr- and Li-infiltrated samples. FIG. 5g shows the ADF image (top) and FIG. 5h elemental mapping of Li—K, Cr-M_{4,5}, and Ce (Pr) K_{2,3} edges (bottom). Similar to the pure Li-infiltrated sample, we find the infiltrated species are uniformly distributed on PCO in the serial infiltrated samples (FIG. 5g and FIG. 8b). Although the presence of Cr can be confirmed by the Cr-L_{2,3} edge intensities in the right panel of FIG. 5h, there are no regions with only Cr-species (FIG. 8c). Instead, the Cr signal is accompanied by those for Li, Ce and Pr, and therefore greatly reduced in intensity. This finding, and the changes in the white-line ratio in the serial infiltrated PCO compared to the Cr-infiltrated PCO (FIGS. 5f and 5h) from the EELS spectra, show that crystalline Cr₂O₃ reacts with the Li-species forming mixed amorphous phases comprising Cr, Li, Ce, Pr, and O. In some cases, the amorphous phase may comprise a glassy and/or crystalline product oxide comprising the basic oxide (e.g., Li₂O) and/or the acidic oxide (e.g., chromia). Based on the STEM observations, the Li-species chemically react with the surface oxide and dissolve both Cr₂O₃ and PCO into an amorphous mixed oxide. This process is likely driven by the strong reactivity of Li with ceria, consistent with the reported use of Li₂O as a sintering aid in the densification of ceria. The glassy and/or crystalline product oxide may form on an electrode when an acidic oxide and a basic oxide are present on the surface of the MIEC oxide (e.g., the PCO oxide) and the electrode is heated to facilitate the relatively slow kinetics of the reaction. For example, in FIG. 5, the formation of such glassy and/or crystalline product oxides occur due to the serial infiltration steps of the acidic and basic oxides with subsequent heating steps (e.g., to remove the nitrates from the precursors species such as LiNO₃).

While the foregoing disclosure primarily describes the electrodes comprising MIEC oxides and basic oxides in the context of fuel cells, the electrodes are useful in a variety of other applications. Non-limiting examples of applications wherein the electrodes may be used include bulk porous ceramics, screen printed thick film layers, electrolysis cells (SOEC), oxygen permeation membranes, oxygen storage materials, solar thermochemical reactors, metal oxide-based catalysts, and gas sensors.

The following examples are intended to illustrate certain embodiments of the present invention, but do not exemplify the full scope of the invention.

### EXAMPLES

### Preparation of Porous PCO Specimen

The Pr_{0.1}Ce_{0.9}O_{2-δ} powder was synthesized by solution combustion route, starting from Ce(NO₃)₃·6H₂O (99.99%, ALFA AESAR), Pr(NO₃)₃·6H₂O (99.99%, ALFA AESAR) precursors and citric acid. The solution was heated on a hot plate and following gel combustion, the reaction resulted in the formation of a reddish powder. The resulting PCO powders were calcined at 750° C., 6 h in ambient air to burn off remaining organic species. The calcined powders were lightly pressed into a rectangular green body at approximately 70 MPa to make a porous specimen and then sintered at 1,450° C. for 3 h to produce a homogeneous grain size. The resulting PCO porous specimen (20.7×6.9×0.9 mm³) was used for electrical conductivity relaxation measurements.

### Electrical Conductivity Relaxation Measurements

For the measurement of PCO conductivity, four gold wires were wound around the PCO specimen with gold paste painted along the wires to obtain better electrical contact. The electrical conductivity transients were performed with a HP3478A digital multimeter in a four-wire resistance measurement mode. The measurements were conducted in an alumina tube at temperatures (275-600° C., depending on infiltrants) with the P_{O}_{₂} step between 0.1 and 0.2 atm controlled by two mass-flow controllers that mixed ultrahigh purity nitrogen and oxygen (grade 5.0, AIRGAS). Cr and Li nitrate-based solutions were prepared for infiltration, respectively, in ethanol to concentrations of 0.002 M (for 0.02 at %) and 0.2 M (more than 0.1 at %) for low and high loading. The pristine PCO specimen without any infiltration was first measured to extract the initial k_{chem} value. Following subsequent infiltration with the Cr-based nitrate solutions, measurements were repeated 3 times until the Cr concentration reached 0.3 at %. This final Cr infiltrated specimen was then serially infiltrated with Li₂O four more times ranging from 0.02 at % to 0.5 at %. The infiltration was performed while the sample was left hanging by its measurement wires so that the entire volume of solution remained inside the porous sample without dripping elsewhere, thereby increasing the precision and repeatability of the infiltration loading. After each infiltration, the specimen was calcined in situ under synthetic air at 600° C. and measurements initiated when stabilization of the conductivity was achieved.

### Microscopy Analysis

The microstructures of pristine and serially infiltrated porous PCO specimen were examined by Zeiss Merlin High-Resolution scanning electron microscopy. The structure and chemical information were observed with a probe-corrected ThermoFisher Scientific THEMIS Z G3 60-300 kV S/TEM operated at 60 kV with a Gatan Continuum electron energy loss spectrometer (EELS). The electron probe current was approximately 25 pA with a probe convergence semi-angle of 30 mrad. The annular dark field imaging inner and outer detector collection semi-angles were 25 and 153 mrad respectively. All samples were prepared by diamond scribing the infiltrated PCO directly onto carbon film on 200 mesh copper transmission electron microscopy (TEM) grids (Ted Pella, Redding, CA). EELS chemical mapping was determined from multiple linear least squares (MLLS) fitting routine using the Gatan Microscopy Suite (GMS) software. The reference spectra for Cr and Ce/Pr were taken from regions in the Cr₂O₃-only infiltrated PCO (0.3 at %). The spectra around the O—K edge and Cr-M_{2,3} edge corroborate the low-loss reference spectra corresponds to the Cr rich regions. Reference spectra for Li were taken from regions in Li-only infiltrated PCO (0.3 at %). The reference spectra for Li—K edge is shown in FIG. 5h along with the spectra in regenerated Li-infiltrated PCO around the Li—K and Cr-M_{4,5} edge (left) and O—K and Cr-L_{2,3} edge (right). The reference spectra for Li—K edge were determined from a Li-only infiltrated PCO. The decrease in elemental intensity towards the bulk of the PCO is due to plural inelastic scattering with material thickness.

### Fabrication of Symmetric Cells

Symmetric cells with PCO/YSZ/PCO configuration were fabricated to measure the area-specific resistance. 70 μl of 1,5-pentanediol (ALFA AESAR, 97%) and 10 μl of an OPTAPIX PAF 35/water (50:50, Zschimmer & Schwarz Inc.) were added to 0.2 g of the PCO powder and ground into a paste using a mortar and pestle. The PCO slurry was screen printed onto one side of a YSZ (100) single crystal substrate (MTI, doubly polished, 10×10×0.5 mm³) and dried for 4 h at room temperature and then overnight at 90° C. This process was repeated onto the second side of the YSZ. The sample was then sintered in a tubular furnace at 1350° C. for 3 h under ambient air. Gold paste (fuel cell materials) was then applied to both sides of each of the prepared PCO electrodes as current collector. The pristine sample was used as is. After measuring the pristine cell, a 0.2 M ethanol solution of Cr-nitrate was used to infiltrate the cell with 0.15 at % Cr (based on an average weight of 0.012 g per electrode after screen printing and calcination). The cell was measured and again infiltrated with 0.4 at % Li using a 0.2 M ethanol solution of Li-nitrate.

### Electrochemical Measurements

Electrochemical analyses of symmetric cells with pristine and infiltrated PCO electrodes were conducted by electrochemical impedance spectroscopy measurements with a SOLARTRON 1255 HF frequency response analyzer interfaced with an EG&G PAR potentiostat model 273A in the frequency range of 0.1 Hz to 1 MHz in the temperature range of 450-650° C. at an oxygen partial pressure between 0.1 and 0.5 atm. The cells were placed in an alumina tube and the gold current collector was connected to a platinum wire under gas mixtures of oxygen and nitrogen delivered through digital mass flow controllers. Distribution relaxation of time (DRT) analyses were carried out with DRT tools to investigate the characteristic process in more detail. The area under P1 was determined using the integrate function of the Peak Analyzer Tool in Origin2020b. The normalization factor was determined by the total area of all peaks to the resistance of the total ASR of the Nyquist plot for the pristine cell at 575° C. This auxiliary equivalent circuit consisted of a series resistance accounting for all higher frequency processes and a resistor in parallel with a constant phase element, which is often referred to as R-Q circuit. The following mathematical representation of the R-Q circuit was chosen in order to directly obtain t and R:

$${Z}_{R Q} ( ω ) = \frac{R}{1 + {( j ωτ )}^{α}}$$

The chemical capacitance was obtained by normalizing the values to the volume of the cell (determined using the weight of the PCO layer and its density).

The flush time corrected relaxation expression was used, which gives a flush time constant τ_{f} as well as a “reaction” time constant τₙ as follow:

$$g ( t ) = 1 - exp ( \frac{- t}{{τ}_{f}} ) - \frac{{τ}_{n}}{{τ}_{n} - {τ}_{f}} ( exp ( \frac{- t}{{τ}_{n}} ) - exp ( \frac{- t}{{τ}_{f}} ) )$$

Table 1 represents comparison of flush time and reaction time constants of different samples (e.g., measured data shown in FIG. 6a). The flush time constant for the oxygen probe is slightly lower than for any of the conductivity samples. This is attributed to the fact that the introduction of the probe into the setup reduces the reactor volume, which leads to a reduced flush time constant. Given that In increases from that of the LSC thin film to that of the porous PCO specimen (1.5 mm thickness), this implies that gas phase diffusion within the pores impacts the measured transient, but only when the temperature is sufficiently high so that the oxygen exchange kinetics begin to drop below the flush time. Indeed, although the porous samples with different thicknesses yield slightly different profiles in the flush time limited regime, the k_{chem} values derived from the profiles measured at lower temperatures are identical (FIG. 6b). Additional set of porous PCO specimens achieved by utilizing different sintering temperatures (1350° C. and 1450° C.), and therefore different levels of porosity, were observed to yield identical time constants (ca. 10 s), as presented in FIG. 7. This agrees well with the values in Table 1.

The importance of utilizing a distribution of time constants in analyzing kinetic data are known, particularly at higher measurement temperatures, when gas diffusion and gas exchange kinetic become comparable. These issues were avoided by measuring the samples in a much lower temperature range. Furthermore, given the flush time is independent of temperature, and gas diffusion is only weakly dependent on temperature, one can conclude that the measurement conditions used in this work are set so that the influence of gas diffusion is negligible.

Bulk oxygen diffusion and surface oxygen exchange kinetics limits

Ignoring gas phase diffusion contributions, the overall relaxation profiles can be readily affected by both bulk oxygen diffusion through the sample and surface oxygen exchange kinetics on the surface. To determine which of the two limits the overall relaxation process, the critical thickness (above which oxygen ion transport through the electrode becomes dominant) has to be considered, which follows as: L_{c}=D/k where D and k are the oxygen diffusion and oxygen exchange coefficients, respectively. The porous specimen prepared in this work has an approximately 1-μm grain size, which is advantageous given the much shorter oxygen ion diffusion length than the critical thickness (3.6×10³ mm at 670° C.). In addition, Lₐ=a/L_{c}=a*k/D<0.03, the surface exchange-controlled kinetic becomes dominant, but if Lₐ>30, oxygen diffusion-controlled kinetics becomes dominant. The calculated value of Lₐ in this case is less than 0.0003<<0.03, clearly indicating surface exchange-controlled kinetics. One concludes that the overall relaxation process under measurement conditions is limited not by oxygen ion diffusion through the sample but by surface oxygen exchange kinetics.

### Profile Fitting in Pristine, Cr- and Serially Cr-/Li-Infiltrated PCO Specimen

### Introduction of Fitting Procedure

Electrical conductivity relaxation measurements can be used to examine bulk oxygen diffusion (D_{chem}) and surface oxygen exchange kinetics (k_{chem}). The electrical conductivity of mixed conducting oxides depends on their oxygen stoichiometry driven by the oxygen activity (i.e., oxygen partial pressure) in the surrounding gas. By monitoring the transient in electrical conductivity through a rapid change in surrounding oxygen partial pressure, one can analyze the characteristics of the kinetics associated with the uptake or release of oxygen from the oxide. As already noted supra, the overall exchange kinetics of a porous PCO specimen used in this work is limited by the surface oxygen exchange kinetics, which can be simply expressed by:

$$\overline{C} ( t ) = \frac{C ( t ) - C \text{?}}{C \text{?} - C \text{?}} = 1 - exp ( - k \text{?} t ) \qquad Equation l$$

$$\text{?} \text{indicates text missing or illegible when filed}$$

where C(t), C₀, and C_{∞} are the concentration of oxygen in the oxide at time t, at the initiation of the step in P_{O}_{₂} and at infinite time, respectively. The geometrical factor A/V corresponds to the surface area to volume ratio of the PCO. The volume V is related to the fraction of porosity p subtracted from the overall geometric volume Vₜₒₜₐₗ of PCO, expressed by V=Vₜₒₜₐₗ(1−p). The porosity p of the PCO specimen is 0.26. The surface area per volume (S_{A}=A/Vₜₒₜₐₗ) was determined by SEM cross-sectional imaging, with a line intersection analysis according to stereology theory. The value of S_{A} (26,500 cm²·cm⁻³) was used. Since the change in concentration of oxygen in the oxide leads to the change in electrical conductivity, Equation 1 can be converted to Equation 2 as follows:

$$g ( t ) = \frac{\text{?} ( t ) - \text{?}}{\text{?}} = 1 - exp ( - \text{?} t ) = 1 - exp ( - \text{?} ) \qquad Equation 2$$

$$\text{?} \text{indicates text missing or illegible when filed}$$

where σ(t), σₐ, and σ_{∞} are the electrical conductivity at time t, and τ is the time constant of the transient. The oxygen exchange coefficient (k_{chem}) can be calculated by using Equation 3:

$${k}_{chem} = \frac{V}{A \cdot t} = \frac{( 1 - p )}{{S}_{A} \cdot τ} \qquad Equation 3$$

### Cr-Infiltrated Specimen

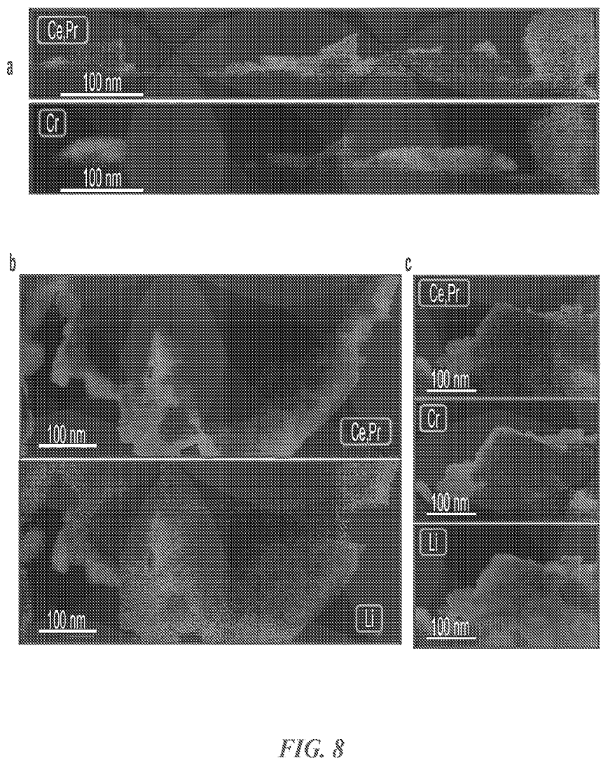

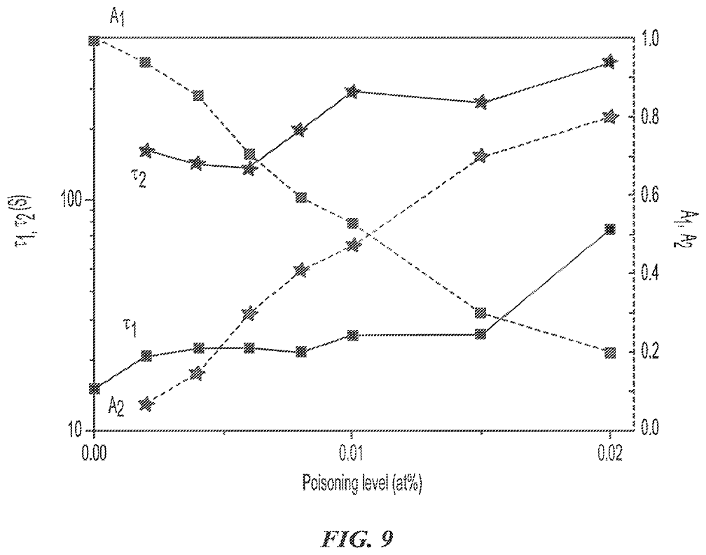

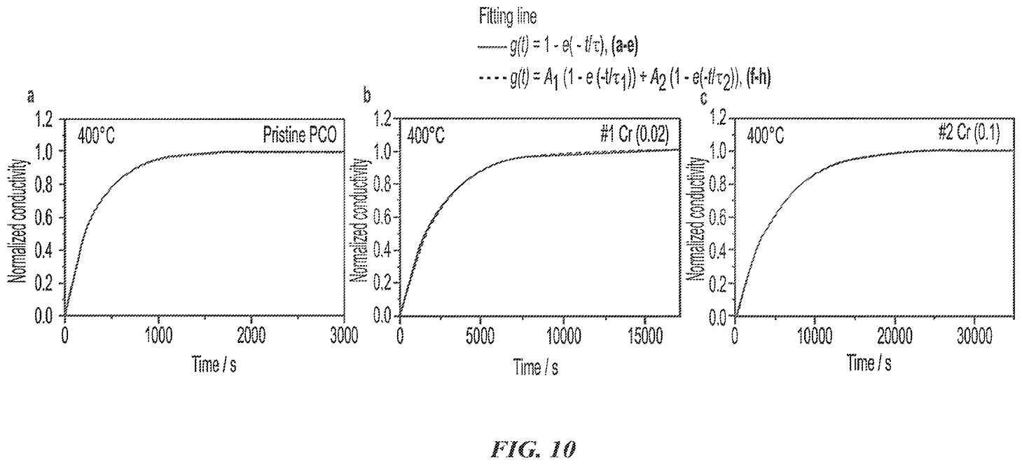

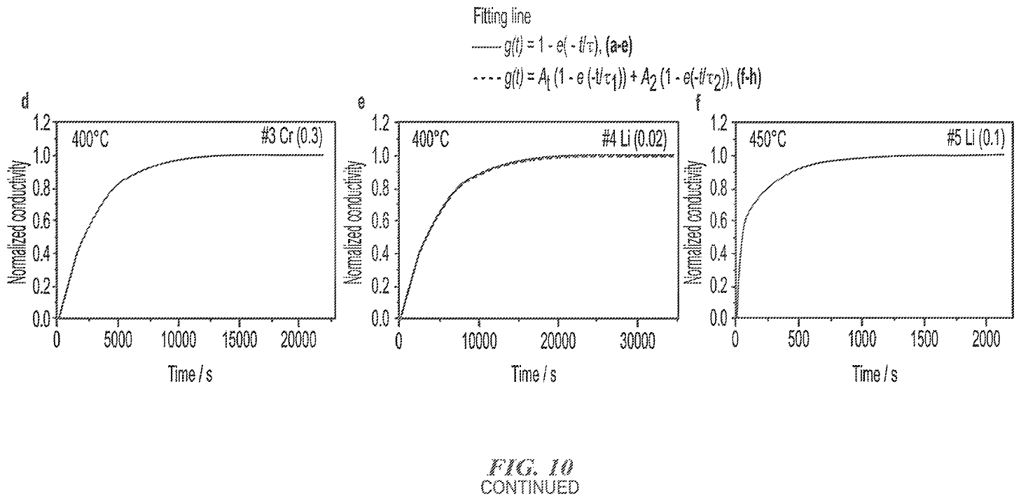

The influence of Cr poisoning on the relaxation profiles was studied in a preliminary work considering much lower Cr loading below 0.02 at %. In that case, two-time constants were necessary to fit the data accurately. It was observed that as the Cr loading amount increases, the A₁ (pristine PCO-rich) fraction decreases while the A₂ (Cr-rich) fraction increases, as shown in FIG. 9. On the other hand, the relaxation profile of Cr-infiltrated PCO specimen (from 0.02 at % to 0.3 at %) could be fitted very well by the single time constant exponential equation. One should keep in mind, that once Cr-species are infiltrated into PCO, the transient rates become much slower than the pristine PCO (factor >20). This is expected for either a dramatically decreased active surface area or much slower kinetics in the region affected by Cr; or both. Observing only one time constant in the relaxation profile at higher Cr-species concentrations can have several reasons: (1) the pristine PCO region becomes negligibly small, (2) the Cr-infiltrated region has negligible oxygen exchange. We can extrapolate that A₁ eventually reaches 0 and the profiles return to a one-time constant shape, in line with what is observed was observed when the Cr-infiltration level was above 0.02 at %. For these reasons, a single time constant exponential equation was chosen to fit the Cr-infiltrated (above 0.02 at % Cr in the PCO) sample instead of using two-time constant exponentials, as presented in FIG. 10b-d.

### Cr-/Li-Infiltrated Specimen

As can be seen in FIG. 10, while the relaxation profiles of the pristine, Cr-infiltrated, and subsequently 0.02 at % Li-infiltrated PCO fit a single time constant (τ) exponential well (green dashed line in FIG. 10a-e), those of serially Li-infiltrated PCO with high concentrations (up to 0.5 at %) are fit well with two-time constant (τ₁ and τ₂) exponentials (dashed line in FIG. 10f-h). Along with observation of the Cr-infiltrated specimen, changes in profiles with high concentrations of Li-infiltration were attributed to the presence of two distinguishable areas with faster (Li-rich) and slower (Cr-rich) kinetics, respectively. A₁ and A₂, corresponding to τ₁ and τ₂ in dashed expression (FIG. 10f-h), are the fractional area for each time constant. Following serial Li-infiltration on a Cr-poisoned PCO surface, the detrimental effect of Cr₂O₃ crystallites on surface kinetics is expected to become less. A₁, A₂, τ₁ and τ₂ values of subsequently Li-infiltrated PCO with high concentrations (0.1 at % to 0.5 at %), obtained by fitting the dashed equation, are summarized in Table 2. As expected, it shows that a continuous shift from the long to the short time constant, as one goes from more Cr-rich (τ₂) to Li-rich (τ₁) compositions. This is further consistent with the corresponding fractional change from large Cr-rich area (A₂) to large Li-rich area (A₁). Average time constant values at high concentrations of Li-infiltration, used in FIG. 2b in the main text, were calculated by use of the following expression:

$${τ}_{average} = {A}_{1} \cdot {τ}_{1} + {A}_{2} \cdot {τ}_{2} .$$

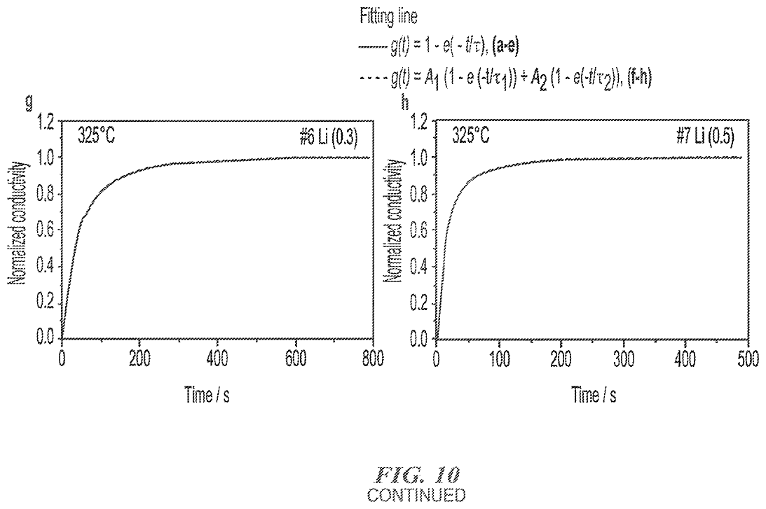

FIG. 11 shows the activation energy for pristine PCO, as well as the activation for PCO samples after different amounts of infiltration of CR and Li (e.g., serial infiltration steps). As outlined with the dashed lines, the activation energy of k_{chem} of the PCO samples show little dependence on infiltration (e.g., with a basic or acidic species).

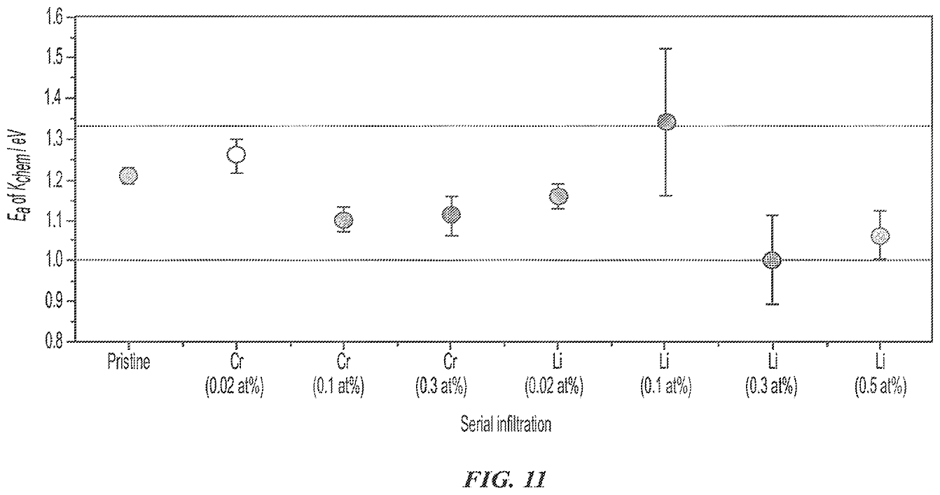

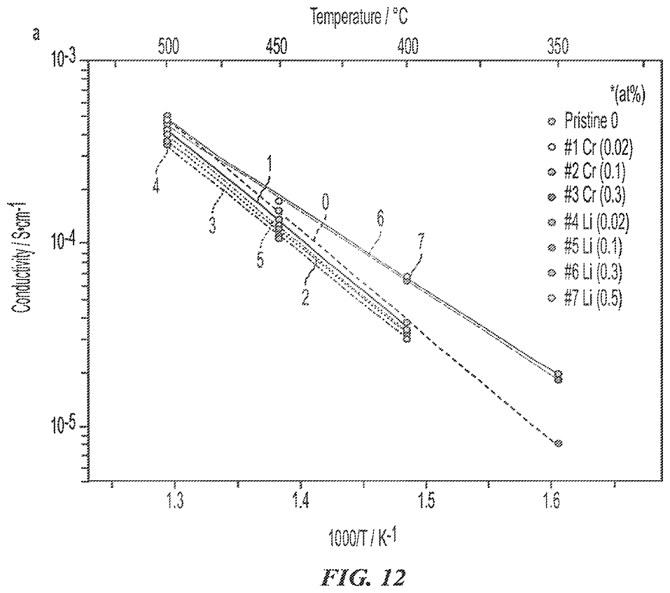

FIGS. 12a and 12b show the overall conductivity and the activation energies (Ea) of conductivity, respectively, of PCO samples that are serially infiltrated with Cr and then Li. Here, the conductivity increases and activation energy of conductivity remain approximately the same up to 0.1 at % Li loading. The conductivity increases and activation energy of conductivity decreases after at least 0.3 at % Li loading.

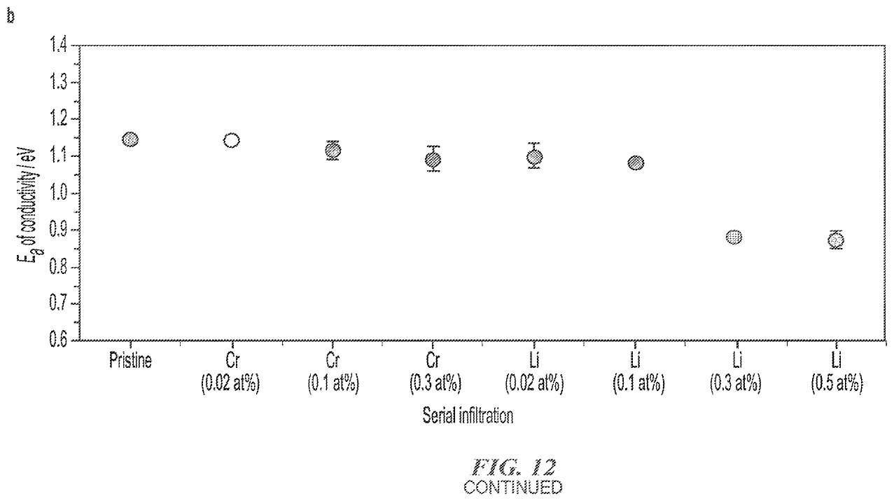

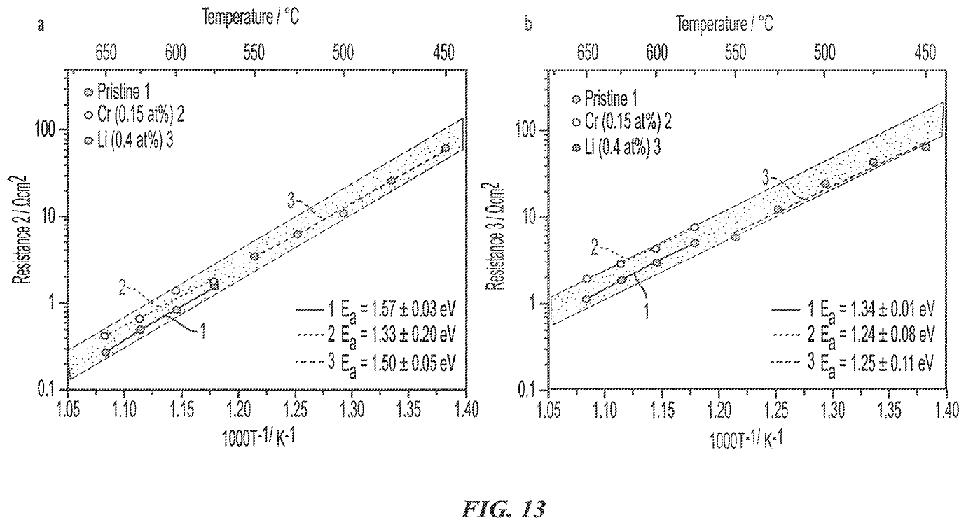

FIG. 13 show the (a) resistance 2 (R2) and (b) resistance 3 (R3) obtained from Nyquist plots of the pristine PCO and after serial infiltration of Cr and then Li are temperature dependent. In both cases of R2 and R3, neither shows significant dependence on infiltration.

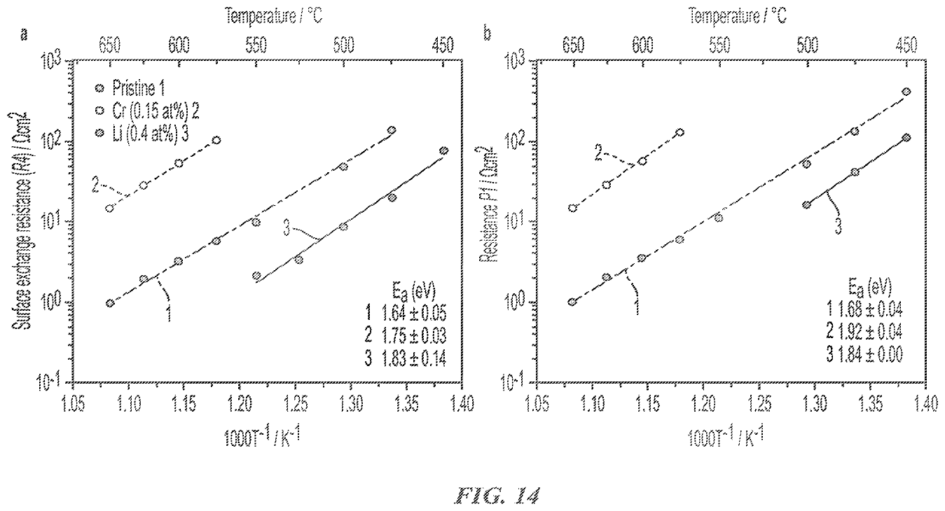

FIG. 14 shows that (a) the surface exchange resistance R4 and the (b) the resistance of P1 of the pristine PCO cell before and after serial infiltration of Cr and then Li, as determined from the Nyquist plot and DRT, respectively, are similar.

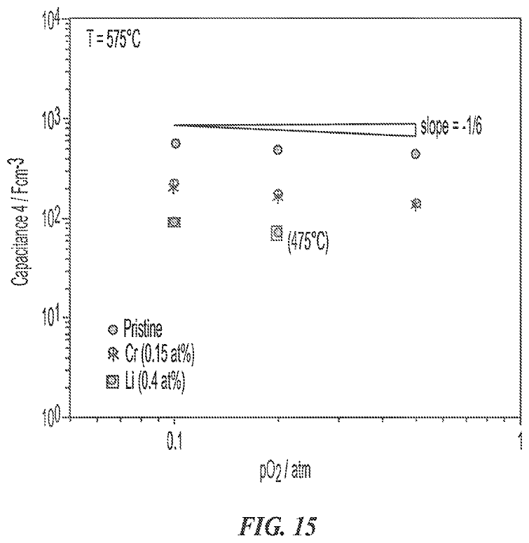

FIG. 15 shows the capacitance C4 as a function of the partial pressure of O₂ for the pristine PCO before and after serial infiltration of the Cr and then Li, derived from fitting the corresponding Nyquist plots. The observed slopes of −⅙ are in line with the typical chemical capacitance of PCO thin films, further confirming that C4 corresponds to surface oxygen exchange processes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03

TABLE 1
Flush time and reaction time constants of porous PCO specimens
with different thickness, LSC thin film and oxygen probe.

| | Flush time constant | Reaction time constant |
|---|---|---|
| Sample | (τ_{f}, sec) | (τₙ, sec) |
| Oxygen probe | 7.6 | 0.63 |
| LSC thin film | 9.2 | 0.71 |
| Porous PCO (0.92 mm | 9.3 | 2.3 |
| thickness) | | |
| Porous PCO (1.5 mm | 9.9 | 3.2 |
| thickness) | | |

TABLE 2
Fitting results of normalized conductivity relaxation transient,
measured on PCO specimen with following successive Cr-
and Li-infiltration at 325° C. through two-time constant
exponential equation, as shown in FIGS. 10f-h.

| | | |
|---|---|---|
| At 325° C. | Li-rich | Cr-rich |

| Samples | A₁ | τ₁ | A₂ | τ₂ |
|---|---|---|---|---|
| #5 Li (0.1 at %) | 0.53* | 32* | 0.47* | 284* |
| #6 Li (0.3 at %) | 0.80 | 40 | 0.20 | 200 |
| #7 Li (0.5 at %) | 0.87 | 16 | 0.13 | 130 |

τ₁ and τ₂: time constant in seconds
A₁ and A₂: fraction for each time constant τ₁ and τ₂
*These values were obtained at 450° C. (not measured at 325° C.)

1. An article, comprising:
a solid oxide fuel cell, comprising:
an electrode, comprising:
a mixed-ionic-electronic-conducting (MIEC) oxide having a surface; and
a basic oxide present on at least a portion of the surface of the MIEC oxide.

2. An electrode, comprising:
a mixed-ionic-electronic-conducting (MIEC) oxide having a surface; and
a glassy and/or crystalline product oxide present on at least a portion of the surface of the MIEC oxide, the glassy and/or crystalline product oxide comprising:
a basic oxide; and
an acidic oxide comprising at least one of chromia and silica.

3. The electrode of claim 2, wherein the glassy and/or crystalline product oxide is present on the surface of the MIEC oxide in an amount greater than or equal to 10⁻¹⁰ g/cm².

4. An electrode, comprising:
a mixed-ionic-electronic-conducting (MIEC) oxide having a surface; and
a basic oxide present on the surface of the MIEC electrode in an amount greater than or equal to 10⁻¹⁰ g/cm² and less than or equal to 10⁻⁶ g/cm².

5-9. (canceled)

10. The article of claim 1, wherein the basic oxide coating has a vapor pressure of less than or equal to 1×10⁻¹² atm at 800° C.

11. The article of claim 1, wherein a rate of performance loss of the fuel cell is less than or equal to 2% per 1000 hours of operation.

12. The article of claim 1, wherein the MIEC comprises a perovskite and/or perovskite-related structure.

13. The article of claim 1, wherein the basic oxide comprises Li₂O and/or CaO.

14. The article of claim 1, wherein the basic oxide comprises Li₂O and CaO.

15. The electrode of claim 2, wherein a first Smith acidity of the glassy and/or crystalline product oxide is lower than a second Smith acidity of an acidic oxide comprising silica and/or chromia.

16. The electrode of claim 2, wherein the glassy and/or crystalline product oxide comprises a reaction product of a basic oxide and an acidic oxide.

17. The article of claim 1, wherein the basic oxide coating is present on less than or equal to 95%, 80%, 50%, 25%, or 5% of the surface area of the MIEC oxide.

18. The article of claim 1, wherein the basic oxide coating exhibits ionic bonding with the surface of the MIEC oxide.

19. The article of claim 1, wherein the basic oxide coating adheres to the surface of the MIEC oxide (e.g., by ionic bonding) without substantially reacting with the MIEC oxide and preserves a microstructure and a chemical composition of the MIEC oxide.

20. The article of claim 1, wherein the basic oxide coating is immobilized to the MIEC oxide surface via predominantly ionic bonding.

21. The article of claim 1, wherein an active fraction of the surface area of the MIEC oxide remains accessible to the oxygen exchange reaction.

22. The electrode of claim 2, wherein the glassy and/or crystalline product oxide covers less than or equal to 5% of the surface of the MIEC oxide.

23. The electrode of claim 2, wherein the glassy and/or crystalline product oxide is present on the surface of the MIEC oxide in an amount of greater than or equal to 10⁻⁶ g/cm².

24-27. (canceled)

28. A method comprising operating a fuel cell comprising the article of claim 1 at a temperature of greater than or equal to 500° C.

29. The article as in claim 1, wherein the fuel cell and/or the electrode is at a temperature of greater than or equal to 500° C.
